(19) United States
(12) Patent Application Publication
(10) Pub. No.: US 2008/0234909 A1
(43) Pub. Date: Sep. 25, 2008

(54) BRAKE CONTROL APPARATUS AND PUMP-UP SYSTEM

(75) Inventors: Katsuya Iwasaki, Isehara-shi (JP); Keigo Kajiyama, Tokyo (JP); Toshiya Oosawa, Yokohama-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/046,720

(22) Filed: Mar. 12, 2008

(30) Foreign Application Priority Data
Mar. 19, 2007 (JP) 2007-070971

(51) Int. Cl. G06F 19/00

(52) U.S. Cl. 701/70

(57) ABSTRACT

A brake control apparatus of an automotive vehicle employs a pump incorporated in a hydraulic actuator, a separate pressure control valve disposed between the pump and each individual wheel-brake cylinder and having an orifice having a predetermined orifice-constriction flow passage area, and vehicle sensors including at least wheel cylinder pressure sensors. Also provided is a controller configured to be connected to the vehicle sensors and the hydraulic actuator, for calculating, based on a driver's manipulated variable, target wheel cylinder pressures, and for controlling the hydraulic actuator responsively to the target wheel cylinder pressures. The controller is further configured for calculating a fluid-pressure deviation between the target wheel cylinder pressure and the actual wheel cylinder pressure, and for stopping working-fluid supply from the pump to the abnormal wheel-brake cylinder having an abnormality in the fluid-pressure deviation exceeding a predetermined threshold value.

### TECHNICAL FIELD

The present invention relates to a pump-up system that pressurizes working fluid by means of a pump, and specifically to a brake control apparatus capable of controlling a braking force by regulating each individual wheel-brake cylinder pressure by means of a brake-by-wire (BBW) control system.

### BACKGROUND ART

In recent years, there have been proposed and developed various automobile brake devices capable of executing brake-by-wire (BBW) control. One such BBW system equipped brake device has been disclosed in Japanese Patent No. 3409721 (hereinafter is referred to as “JP3409721”), corresponding to U.S. Pat. No. 6,913,326. In the brake device disclosed in JP3409721, a brake pedal is shut off from each individual wheel-brake cylinder, a master-cylinder pressure sensor is provided to detect a master-cylinder pressure, a stroke simulator is disposed between the brake pedal and the master cylinder, and a stroke sensor is provided to detect a depression stroke of the brake pedal. Target wheel cylinder pressures are calculated based on sensor signal values from the stroke sensor and the master-cylinder pressure sensor. Required wheel-brake cylinder pressures are attained by controllably driving a pump motor and electromagnetic valves based on the calculated target wheel cylinder pressures.

### SUMMARY OF THE INVENTION

In the presence of a leak of working fluid due to a brake system failure, such as a failure in a brake line through which a hydraulic unit and a wheel-brake cylinder are connected to each other, or a failure in the wheel-brake cylinder itself, the brake device disclosed in JP3409721 is designed to compensate the undesirably leaked working fluid by rising a pump discharge pressure up to a higher value as compared to a required pressure value in the absence of a working-fluid leak. However, owing to working fluid leaked out of the hydraulic brake system (e.g., the failed wheel-brake cylinder), there is a possibility that a wheel cylinder pressure in an unfailed wheel-brake cylinder, which is operating normally, undesirably drops. In such a situation, it is impossible to satisfactorily ensure a required braking force.

It is, therefore, in view of the previously-described disadvantages of the prior art, an object of the invention to provide a brake control apparatus capable of ensuring a sufficient braking force, while suppressing the amount of working fluid leaked out owing to a hydraulic brake system failure to a minimum.

In order to accomplish the aforementioned and other objects of the present invention, a brake control apparatus of an automotive vehicle comprises wheel-brake cylinders mounted on each of at least two road wheels, pressure sensors provided for detecting actual wheel cylinder pressures in the respective wheel-brake cylinders, a vehicle sensor provided for detecting a driver's manipulated variable, at least one hydraulic actuator configured to regulate the actual wheel cylinder pressures, at least one pump incorporated in the hydraulic actuator, a separate pressure buildup valve disposed in each separate wheel-brake line through which working fluid discharged from the pump is introduced into each of the wheel-brake cylinders, the pressure buildup valve having an orifice having a predetermined orifice-constriction flow passage area, a controller configured to be connected to at least the pressure sensors, the vehicle sensor, and the hydraulic actuator, for calculating, based on the driver's manipulated variable, target wheel cylinder pressures, and for controlling the hydraulic actuator responsively to the target wheel cylinder pressures, the controller configured to calculate a fluid-pressure deviation between the target wheel cylinder pressure and the actual wheel cylinder pressure for each of the wheel-brake cylinders, and the controller further configured to stop working-fluid supply from the pump to the abnormal wheel-brake cylinder having an abnormality in the fluid-pressure deviation exceeding a predetermined threshold value.

According to another aspect of the invention, a brake control apparatus of an automotive vehicle comprises wheel-brake cylinders mounted on each of at least two road wheels, a fluid-pressure sensor means for detecting actual wheel cylinder pressures in the respective wheel-brake cylinders, a vehicle sensor means for detecting a driver's manipulated variable, at least one hydraulic actuator configured to regulate the actual wheel cylinder pressures, a fluid-pressure supply means incorporated in the hydraulic actuator, a flow-constriction valve means disposed in each separate wheel-brake line through which working fluid discharged from the fluid-pressure supply means is introduced into each of the wheel-brake cylinders, the flow-constriction valve means having an orifice having a predetermined orifice-constriction flow passage area, a control means configured to be connected to at least the fluid-pressure sensor means, the vehicle sensor means, and the hydraulic actuator, for calculating, based on the driver's manipulated variable, target wheel cylinder pressures, and for controlling the hydraulic actuator responsively to the target wheel cylinder pressures, a fluid-pressure deviation arithmetic-calculation-and-logic means for calculating a fluid-pressure deviation between the target wheel cylinder pressure and the actual wheel cylinder pressure for each of the wheel-brake cylinders and for deciding that there is an abnormality in the fluid-pressure deviation when the fluid-pressure deviation exceeds a predetermined threshold value, and the control means further configured to stop working-fluid supply from the fluid-pressure supply means to the abnormal wheel-brake cylinder having the abnormality in the fluid-pressure deviation exceeding the predetermined threshold value, when the fluid-pressure deviation arithmetic-calculation-and-logic means decides that there is the abnormality in the fluid-pressure deviation.

According to a further aspect of the invention, a pump-up system comprises a pump, a motor that drives the pump, a plurality of fluid-pressure-control controlled systems, each of which is connected to the pump, pressure sensors provided for detecting actual fluid pressures in the respective fluid-pressure-control controlled systems, a vehicle sensor provided for detecting a driver's manipulated variable, a separate control valve disposed in each separate fluid line through which working fluid discharged from the pump is introduced into each of the fluid-pressure-control controlled systems, the control valve having an orifice having a predetermined orifice-constriction flow passage area, a controller configured to be connected to at least the pressure sensors, the vehicle sensor, and the motor, for calculating, based on the driver's manipulated variable, target fluid pressures in the fluid-pressure-control controlled systems, and for controlling the motor responsively to the target fluid pressures, the controller configured to calculate a fluid-pressure deviation between the target fluid pressure and the actual fluid pressure for each of the fluid-pressure-control controlled systems, and the controller further configured to stop working-fluid supply from the pump to the abnormal fluid-pressure-control controlled system having an abnormality in the fluid-pressure deviation exceeding a predetermined threshold value.

The other objects and features of this invention will become understood from the following description with reference to the accompanying drawings.

### BRIEF DESCRIPTION OF THE DRAWINGS

FIG. 1 is a system diagram illustrating a first embodiment of a brake control apparatus.

FIG. 2 is a hydraulic circuit diagram illustrating a hydraulic unit employed in the brake control apparatus of the first embodiment.

FIG. 3 is a main flow chart illustrating a leak detection control routine in the control apparatus of the first embodiment.

FIG. 4 is a flow chart illustrating a fluid-pressure deviation ΔP abnormality decision routine in the control apparatus of the first embodiment.

FIG. 5 is a flow chart illustrating an inflow quantity Qin arithmetic routine in the control apparatus of the first embodiment, for calculation of the inflow of working fluid flown into a wheel-brake cylinder.

FIG. 6 is a flow chart illustrating an outflow quantity Qp arithmetic routine in the control apparatus of the first embodiment, for calculation of the outflow of working fluid discharged from a pump employed in the brake control apparatus of the first embodiment.

FIG. 7 is an inflow quantity arithmetic routine related to FIG. 5, for calculation of an inflow quantity QinFL of working fluid flown into a front-left wheel-brake cylinder W/C(FL) and an inflow quantity QinFR of working fluid flown into a front-right wheel-brake cylinder W/C(FR).

FIGS. 8A-8D are time charts for leak detection control executed within the brake control apparatus of the first embodiment.

FIG. 9 is a system diagram illustrating a second embodiment of a brake control apparatus.

FIG. 10 is a hydraulic circuit diagram illustrating a hydraulic unit employed in the brake control apparatus of the second embodiment.

FIG. 11 is a main flow chart illustrating a leak detection control routine in the control apparatus of the second embodiment.

FIG. 12 is a flow chart illustrating a fluid-pressure deviation ΔP abnormality decision routine in the control apparatus of the second embodiment.

FIG. 13 is a flow chart illustrating an inflow quantity Qin arithmetic routine in the control apparatus of the second embodiment, for calculation of the inflow of working fluid flown into a wheel-brake cylinder.

FIG. 14 is an inflow quantity Qin arithmetic routine related to FIG. 13, for calculation of four inflow quantities QinFL, QinFR, QinRL, and QinRR of four wheel-brake cylinders W/C(FL), W/C(FR), W/C(RL), and W/C(RR).

FIG. 15 is a system diagram illustrating a third embodiment of a brake control apparatus.

FIG. 16 is a hydraulic circuit diagram illustrating a first hydraulic unit HU1 employed in the brake control apparatus of the third embodiment.

FIG. 17 is a hydraulic circuit diagram illustrating a second hydraulic unit HU2 employed in the brake control apparatus of the third embodiment.

FIG. 18 is a system diagram illustrating a fourth embodiment of a brake control apparatus.

FIG. 19 is a hydraulic circuit diagram illustrating a first hydraulic unit HU1 employed in the brake control apparatus of the fourth embodiment.

FIG. 20 is a hydraulic circuit diagram illustrating a second hydraulic unit HU2 employed in the brake control apparatus of the fourth embodiment.

FIG. 21 is a system diagram illustrating a modification, which is modified from the first embodiment in such a manner as to include an additional fluid-pressure deviation calculation device and an additional leak detector, both separated from a main ECU and a sub-ECU.

FIG. 22 is another modification in which the inventive concept is applied to a pump-up system such as a hydraulic-power-cylinder equipped power steering device.

### DESCRIPTION OF THE PREFERRED EMBODIMENTS

### First Embodiment

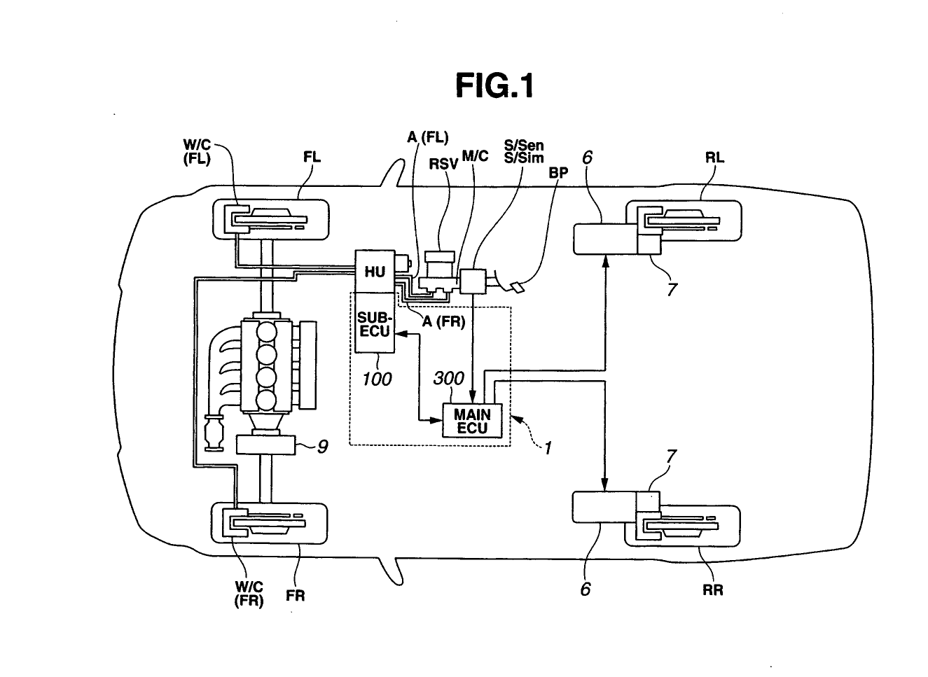

Referring now to the drawings, particularly to FIGS. 1-8D, there is shown the brake control apparatus of the first embodiment.

[Brake System Configuration]

FIG. 1 shows the brake control system configuration of the brake control apparatus of the first embodiment. The brake control apparatus of FIG. 1 is exemplified in a brake-by-wire (BBW) system equipped brake device employing a common hydraulic unit (or a common hydraulic modulator) HU configured to regulate or modulate working fluid pressures Pfl and Pfr for only front-left and front-right wheel-brake cylinders W/C(FL) and W/C(FR) by a pump discharge pressure, independently of a manipulation (a depression) of a brake pedal BP by the driver.

Hydraulic unit HU common to front-left and front-right hydraulic brakes is driven by means of a sub-electronic control unit (sub-ECU) 100. On the other hand, regarding each of rear brakes for rear-left and rear-right road wheels RL-RR, a dynamo-electric brake (or an electric-operated brake caliper 7) is used instead of using a hydraulic brake.

A stroke simulator S/Sim is provided at a master cylinder M/C. A reaction force applied to brake pedal BP is created by means of stroke simulator S/Sim connected to master cylinder M/C. A stroke sensor S/Sen is also provided at master cylinder M/C. When depressing brake pedal BP, a fluid pressure (i.e., a master-cylinder pressure Pm) in master cylinder M/C is produced, and stroke sensor S/Sen generates a stroke signal S substantially corresponding to an amount of depression of brake pedal BP. Stroke signal S is outputted into a main electronic control unit (main ECU) 300.

Master cylinder M/C is a tandem master cylinder with two pistons set in tandem. A first hydraulic-brake system path of hydraulic unit HU is connected via a fluid line A(FL) to a first port of master cylinder M/C, whereas a second hydraulic-brake system path of hydraulic unit HU is connected via a fluid line A(FR) to a second port of master cylinder M/C. The primary and secondary pressure chambers of master cylinder M/C are connected to a master-cylinder reservoir RSV. Thus, master-cylinder pressure Pm, created by depression of brake pedal BP, is supplied via the fluid line A(FL) to the first system path of hydraulic unit HU, and at the same time the master-cylinder pressure Pm is supplied via the fluid line A(FR) to the second system path of hydraulic unit HU. Fluid pressure control of each of front-left and front-right wheel-brake cylinders W/C(FL) and W/C(FR) is performed by driving or operating hydraulic unit HU by means of sub-ECU 100. Thereafter, a regulated hydraulic pressure is supplied via a fluid line D(FL) to front-left wheel-brake cylinder W/C(FL), while a regulated hydraulic pressure is supplied via a fluid line D(FR) to front-right wheel-brake cylinder W/C(FR).

Main ECU 300 includes a central processing unit (CPU) that calculates, based on the sensor signals, a target front-left wheel cylinder pressure P*fl and a target front-right wheel cylinder pressure P*fr for hydraulic unit HU. Main ECU 300 is configured to electrically connected to sub-ECU 100, for driving or operating hydraulic unit HU via sub-ECU 100, for fluid pressure control of each of front wheel-brake cylinders W/C(FL) and W/C(FR). Also provided is a regenerative brake device 9, by means of which regenerative cooperative brake control is made to front-left and front-right road wheels FL-FR during braking. Also provided are rear brake actuators 6, 6, each of which controls or adjusts a braking force of electric-operated brake caliper 7 responsively to a command signal from main ECU 300.

During normal braking operation via the BBW system, hydraulic unit HU acts to block fluid communication between master cylinder M/C and each of front wheel-brake cylinders W/C(FL)-W/C(FR). In order to generate a braking force a fluid pressure (pressurized working fluid) is supplied to each of front wheel-brake cylinders W/C(FL)-W/C(FR) by means of a pump P (a fluid pressure source or fluid-pressure supply means), which is built or incorporated in hydraulic unit HU. When a wheel lock-up tends to occur owing to a braking action during vehicle driving on a so-called low-μ road surface having a low friction coefficient, in order to avoid the wheel lock-up, pressure buildup valves, which valves are built in hydraulic unit HU, are operated in such a manner as to suppress or prevent fluid-pressure supply from master cylinder M/C to front wheel-brake cylinders W/C(FL)-W/C(FR). Simultaneously, pressure reduction valves, which valves are built in hydraulic unit HU, are operated in such a manner as to properly reduce wheel cylinder pressures Pfl-Pfr in front-left and front-right wheel-brake cylinders W/C(FL)-W/C(FR), so as to produce a proper braking force, while avoiding the wheel lock-up.

In contrast, in the presence of a functional failure of the BBW system, the operating mode of the BBW system is switched to a manual brake mode at which master-cylinder pressure Pm is delivered directly to front-left and front-right wheel-brake cylinders W/C(FL)-W/C(FR) so as to produce a braking force based on the master-cylinder pressure.

[Hydraulic Circuit]

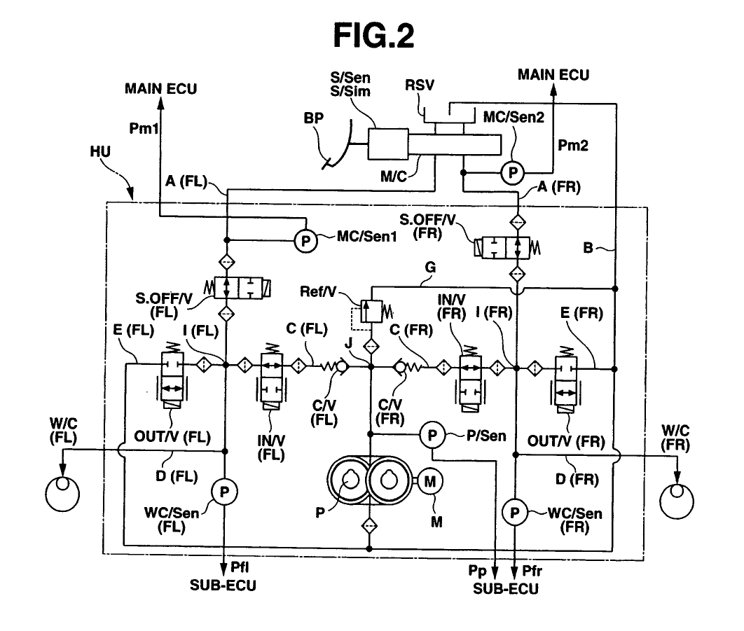

Referring to FIG. 2, there is shown a hydraulic circuit diagram of hydraulic unit HU employed in the brake control apparatus of the first embodiment. The discharge side (a pump outlet) of pump P is connected via a fluid line C(FL) to front-left wheel-brake cylinder W/C(FL), while the same pump outlet is connected via a fluid line C(FR) to front-right wheel-brake cylinder W/C(FR). The suction side (a pump inlet) of pump P is connected via a fluid line B to master-cylinder reservoir RSV. Fluid line C(FL) is connected via a fluid line E(FL) to fluid line B, whereas fluid line C(FR) is connected via a fluid line E(FR) to fluid line B.

The joining point I(FL) of fluid lines C(FL) and E(FL) is connected via fluid line A(FL) included in the first hydraulic-brake system of hydraulic unit HU to the first port of master cylinder M/C. In a similar manner, the joining point I(FR) of fluid lines C(FR) and E(FR) is connected via fluid line A(FR) included in the second hydraulic-brake system of hydraulic unit HU to the second port of master cylinder M/C. The joining point J of fluid lines C(FL) and C(FR) is connected via a fluid line G to fluid line B.

A first brake-system shutoff valve S.OFF/V(FL) is comprised of a normally-open electromagnetic valve, and fluidly disposed in fluid line A(FL) for establishing or blocking fluid communication between master cylinder M/C and joining point I(FL). A second brake-system shutoff valve S.OFF/V(FR) is comprised of a normally-open electromagnetic valve, and fluidly disposed in fluid line A(FR) for establishing or blocking fluid communication between master cylinder M/C and joining point I(FR).

A front-left inflow valve IN/V(FL) is fluidly disposed in fluid line C(FL), and comprised of a normally-open proportional control valve that regulates the discharge pressure produced by pump P by way of proportional control action and then supplies the proportional-controlled fluid pressure to front-left wheel-brake cylinder W/C(FL). Similarly, front-right inflow valve IN/V(FR) is fluidly disposed in fluid line C(FR), and comprised of a normally-open proportional control valve that regulates the discharge pressure produced by pump P by way of proportional control action and then supplies the proportional-controlled fluid pressure to front-right wheel-brake cylinder W/C(FR). Each of front-left and front-right inflow valves (flow-constriction valve means) IN/V(FL)-IN/V(FR) serves as a pressure buildup valve having a flow-constriction throttling portion (or an orifice ensuring an orifice constriction effect) disposed between pump P and the associated wheel-brake cylinder W/C(Fl, FR) and having a predetermined flow passage area (corresponding to an orifice-constriction flow passage area “A” described later). Backflow-prevention check valves C/V(FL)-C/V(FR) are fluidly disposed in respective fluid lines C(FL)-C(FR) to prevent working fluid from flowing back to the discharge port of pump P.

Front-left and front-right outflow valves OUT/V(FL)-OUT/V(FR) are fluidly disposed in respective fluid lines E(FL)-E(FR). Each of front-left and front-right outflow valves OUT/V(FL)-OUT/V(FR) is comprised of a normally-closed proportional control valve. A relief valve Ref/V is fluidly disposed in fluid line G via which joining point J and fluid line B are connected to each other.

A first master-cylinder pressure sensor MC/Sen1 is provided or screwed into fluid line A(FL) interconnecting first brake-system shutoff valve S.OFF/V(FL) and the first port of master cylinder M/C, for detecting a master-cylinder pressure Pm1 and for generating a signal indicative of the detected master-cylinder pressure Pm1 to main ECU 300. Similarly, a second master-cylinder pressure sensor MC/Sen2 is provided or screwed into fluid line A(FR) interconnecting second brake-system shutoff valve S.OFF/V(FR) and the second port of master cylinder M/C, for detecting a master-cylinder pressure Pm2 and for generating a signal indicative of the detected master-cylinder pressure Pm2 to main ECU 300.

Front-left and front-right wheel-cylinder pressure sensors (fluid-pressure sensor means) WC/Sen(FL)-WC/Sen(FR) are incorporated into hydraulic unit HU and provided or screwed into respective fluid lines C(FL)-C(FR), for detecting actual front-left and front-right wheel cylinder pressures Pfl and Pfr. A pump discharge pressure sensor P/Sen is provided or screwed into the discharge line of pump P for detecting a discharge pressure Pp discharged from pump P. Signals indicative of the detected values Pfl, Pfr, and Pp are generated from the respective sensors WC/Sen(FL)-WC/Sen(FR) and P/Sen to sub-ECU 100.

[Normal Braking During Brake-by-Wire Control]

(During Pressure Buildup)

During normal braking at a pressure buildup mode via the two-wheel BBW system, shutoff valves S.OFF/V(FL)-S.OFF/V(FR) are kept closed, inflow valves IN/V(FL)-IN/V(FR) are kept open, outflow valves OUT/V(FL)-OUT/V(FR) are kept closed, and a motor M for pump P is rotated. Pump P is driven by motor M, and thus a discharge pressure is supplied from pump P through the pump discharge line to fluid lines C(FL)-C(FR). In this manner, a pressure buildup mode for each of front-left and front-right wheel cylinder pressures Pfl-Pfr can be achieved by way of motor speed control of motor M.

(During Pressure Reduction)

During normal braking at a pressure reduction mode, outflow valves OUT/V(FL)-OUT/V(FR) are switched to their valve-open states, while retaining inflow valves IN/V(FL)-IN/V(FR) opened. Thus, front-left and front-right wheel cylinder pressures Pfl-Pfr are relieved through outflow valves OUT/V(FL)-OUT/V(FR) via fluid line B into master-cylinder reservoir RSV.

(During Pressure Hold)

During normal braking at a pressure hold mode, motor M is stopped and outflow valves OUT/V(FL)-OUT/V(FR) are all kept closed, so as to hold or retain front-left and front-right wheel cylinder pressures Pfl-Pfr unchanged.

[Manual Brake in Presence of BBW System Failure]

When the operating mode of the two-wheel BBW system equipped brake control apparatus has been switched to a manual brake mode owing to a functional failure of the two-wheel BBW system, shutoff valves S.OFF/V(FL)-S.OFF/V(FR) become kept open. As a result of this, front-left and front-right wheel-brake cylinders W/C(FL)-W/C(FR) become conditioned in their master-cylinder pressure application states. In this manner, the manual brake mode can be achieved or ensured.

[Abnormality Detection Control]

Suppose that a working fluid leak occurs owing to a failure in wheel-brake cylinder W/C(FL, FR) itself or a failure in the brake line through which hydraulic unit HU and wheel-brake cylinder W/C(FL, FR) are connected to each other. In such a situation, it is impossible to satisfactorily ensure a required braking force without compensating the leaked working fluid or without suppressing the amount of working fluid leaked out from the hydraulic brake system (e.g., the failed wheel-brake cylinder) to a minimum. Therefore, when a working fluid leak (an abnormality in the hydraulic brake system) is detected, the brake control apparatus of the first embodiment fully closes (or to shuts off) inflow valve IN/V connected to or associated with the leaking portion of the hydraulic brake system or the failed wheel-brake cylinder, which cylinder is leaking.

In the brake control apparatus, almost all leaks tend to occur in a brake line through which hydraulic unit HU and wheel-brake cylinder W/C(FL, FR) are connected to each other or in the wheel-brake cylinder itself. First, the brake control apparatus of the first embodiment determines or specifies which of the brake lines associated with front-left and front-right wheel-brake cylinders W/C(FL)-W/C(FR) is leaking (failed) or which of two wheel-brake cylinders W/C(FL)-W/C(FR) is leaking (failed). Second, the brake control apparatus shifts the inflow valve IN/V associated with the failed brake line or the failed wheel-brake cylinder, which is leaking, to its shut-off position.

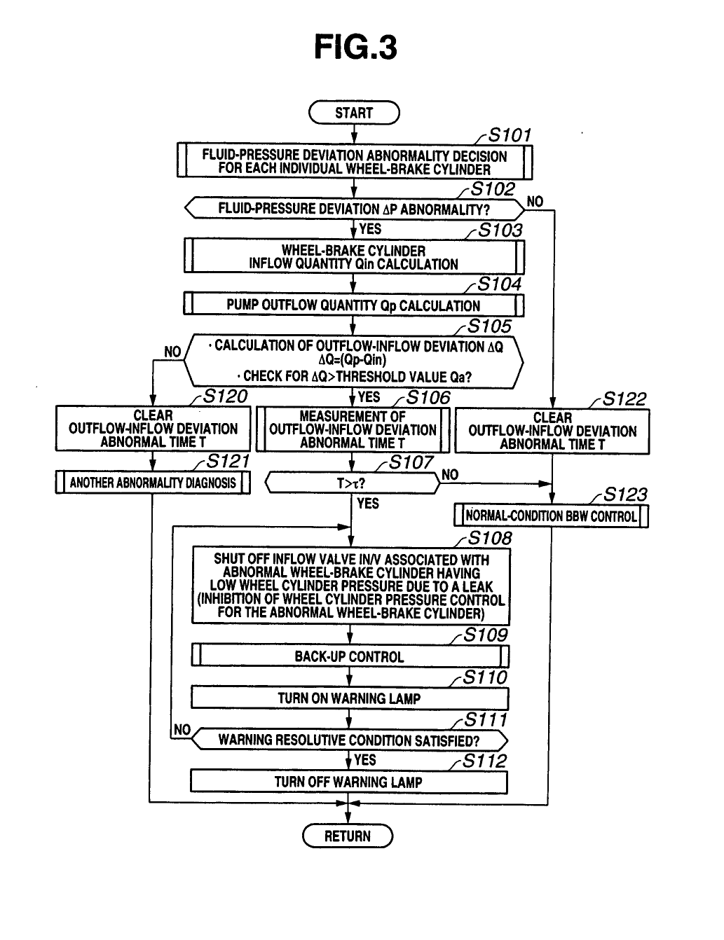

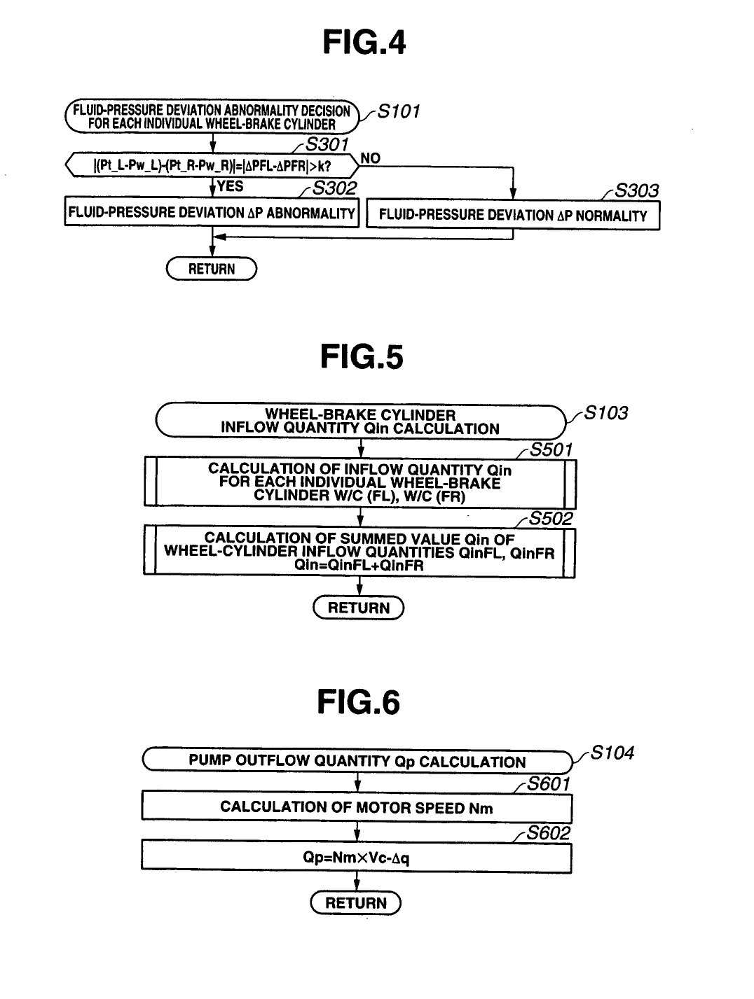

During abnormality detection control (or during leak detection control), first of all, a fluid-pressure deviation ΔP (ΔPFL, ΔPFR) for each individual front wheel-brake cylinder W/C(FL, FR) is calculated. Concretely, front-left wheel-brake fluid-pressure deviation ΔPFL is calculated as a deviation (Pt_L−Pw_L) between target front-left wheel cylinder pressure P*fl (=Pt_L) and actual front-left wheel cylinder pressure Pfl (=Pw_L), and at the same time front-right wheel-brake fluid-pressure deviation ΔPFR is calculated as a deviation (Pt_R−Pw_R) between target front-right wheel cylinder pressure P*fr (=Pt_R) and actual front-right wheel cylinder pressure Pfr (=Pw_R). Then, an absolute value |ΔPFL−ΔPFR| of the deviation-to-deviation difference (ΔPFL−ΔPFR) between front-left and front-right wheel-brake fluid-pressure deviations ΔPFL and ΔPFR is calculated. Next, a comparison between the absolute value |ΔPFL−ΔPFR| and a predetermined threshold value k is made. When the absolute value |ΔPFL−ΔPFR| is greater than the predetermined threshold value k, that is, when |ΔPFL−ΔPFR|>k, it is determined that an abnormality in fluid-pressure deviation ΔP between the front-left and front-right wheel-brake cylinders occurs, in other words, a leak or a fluid-pressure sensor failure occurs (see FIG. 4 and step S101 shown in FIG. 3). For instance, when the front-left wheel-brake cylinder W/C(FL) itself is leaking and the front-right wheel-brake cylinder W/C(FR) is normally operating, the difference |ΔPFL−ΔPFR| becomes substantially identical to the deviation |ΔPFL|, because of an almost zero deviation ΔPFR. Conversely when the front-right wheel-brake cylinder W/C(FR) itself is leaking and the front-left wheel-brake cylinder W/C(FL) is normally operating, the difference |ΔPFL−ΔPFR| becomes substantially identical to the deviation |ΔPFR|, because of an almost zero deviation ΔPFL. As a result, an abnormality in fluid-pressure deviation ΔP can be detected or decided by comparison of fluid-pressure deviation ΔP(FL, FR) with predetermined threshold value k.

Next, an inflow quantity Qin(FL) of working fluid (brake fluid) flown into front-left wheel-brake cylinder W/C(FL) and an inflow quantity Qin(FR) of working fluid flown into front-right wheel-brake cylinder W/C(FR) are calculated (see step S103 of FIG. 3). An outflow quantity Qp of working fluid discharged from pump P is calculated (see step S104 of FIG. 3). The outflow-inflow deviation ΔQ (=Qp−Qin) between the outflow quantity Qp of pump P and the inflow quantity Qin(FL, FR) of each of front wheel-brake cylinders W/C(FL)-W/C(FR) is calculated, and then the calculated outflow-inflow deviation ΔQ is compared to a predetermined threshold value Qa (see step S105 of FIG. 3). When the calculated outflow-inflow deviation ΔQ (=Qp−Qin) exceeds predetermined threshold value Qa (i.e., (Qp−Qin)>Qa), it is determined that an abnormality in fluid-pressure deviation ΔP occurs owing to a leak or a fluid-pressure sensor failure, and then an elapsed time T is measured from a point of time when a transition from a first state defined by (Qp−Qin)≦Qa to a second state defined by (Qp−Qin)>Qa occurs (see the flow (S105→S106) from step S105 to step S106 in FIG. 3). Conversely when the calculated outflow-inflow deviation ΔQ (=Qp−Qin) is less than or equal to predetermined threshold value Qa (i.e., (Qp−Qin)≦Qa), it is determined that an abnormality in fluid-pressure deviation ΔP occurs owing to a factor except a leak and/or a fluid-pressure sensor failure, and then another abnormality diagnosis (another failure diagnosis) is made (see the flow S105→S120→S121 in FIG. 3).

When the second state {(Qp−Qin)>Qa} continues for a predetermined time duration τ after the transition from the first state {(Qp−Qin)≦Qa} to the second state {(Qp−Qin)>Qa}, in other words, immediately when the elapsed time T reaches and exceeds the predetermined time duration τ, that is, when T>τ, it is determined that an abnormality in fluid-pressure deviation ΔP occurs owing to a leak rather than a fluid-pressure sensor failure. Thus, the inflow valve IN/V associated with the abnormal (malfunctioning) wheel-brake cylinder having a relatively low wheel cylinder pressure is shifted to its shut-off position, for inhibiting or stopping or shutting off working-fluid supply to the abnormal wheel-brake cylinder (see step S108 of FIG. 3), so as to avoid or prevent working fluid (brake fluid) from undesirably leaking out from the hydraulic brake system (e.g., the failed wheel-brake cylinder). Conversely when the second state {(Qp−Qin)>Qa} does not continue for predetermined time duration τ after the transition from the first state {(Qp−Qin)≦Qa} to the second state {(Qp−Qin)>Qa}, it is determined that an abnormality in fluid-pressure deviation ΔP does not occur. Thus, normal-condition brake-by-wire (BBW) control is executed (see the flow S107→Sl23 in FIG. 3).

When shutting off (fully closing) the inflow valve IN/V associated with the abnormal wheel-brake cylinder (or the failed wheel-brake cylinder) in the presence of an abnormality of the hydraulic brake system (a working-fluid leakage), as a matter of course, the number of the normally-operating wheel-brake cylinders tends to reduce (for example, 4→3, in case of one abnormal wheel brake in a four-wheeled vehicle with two front hydraulic wheel brakes and two rear electric-operated brake calipers 7, 7). This means a reduction in the total of braking forces applied to the vehicle. To avoid this, the brake control apparatus of the shown embodiment is configured to build up the pump discharge pressure by way of motor speed increase control for motor M, for the purpose of increasing a braking force produced by the normally-operating wheel-brake cylinder, thereby ensuring a required braking force to be applied to the vehicle (see back-up control executed through step S109 in FIG. 3).

Suppose that a hydraulic system maximum flow quantity of working fluid, supplied from pump P into hydraulic unit HU and regulated by hydraulic unit HU, is denoted by “Q”, an inflow-valve fore-and-aft differential pressure between a fluid pressure upstream of inflow valve IN/V and a fluid pressure downstream of the same inflow valve IN/V is denoted by “Pv”, a density of working fluid is denoted by “ρ”, a flow coefficient (a capacity coefficient) of inflow valve IN/V is denoted by “C”, a fore-and-aft differential pressure (an upstream-and-downstream differential pressure) of inflow valve IN/V associated with a failed (or abnormal or malfunctioning) wheel-brake cylinder (having an abnormality in fluid-pressure deviation ΔP) is regarded as to be equal to a left-and-right wheel-cylinder pressure difference used or needed to detect an abnormality in the hydraulic brake system such as a working-fluid leak or a fluid-pressure sensor failure and denoted by “Pv1”, and a fore-and-aft differential pressure (an upstream-and-downstream differential pressure) of the inflow valve IN/V associated with the failed (or abnormal or malfunctioning) wheel-brake cylinder is also regarded as to be equal to a necessary wheel cylinder pressure required for a normally-operating wheel-brake cylinder (not having an abnormality in fluid-pressure deviation ΔP) for ensuring a braking force in the presence of an abnormality in the hydraulic brake system (an abnormality in fluid-pressure deviation ΔP) and denoted by “Pv2”. An orifice-constriction flow passage area “A” of the orifice portion of each of inflow valves IN/V(FL, FR) is set or adjusted to satisfy the following two mathematical expressions.

PV=(Q²·ρ)/(2·A²·C²) (a)

Pv(max)≧(Pv1,Pv2) (b)

The above-mentioned expression (b) means or defines that a higher one MAX(Pv1, Pv2) of the two fore-and-aft differential pressures Pv1 and Pv2 is selected as the inflow-valve fore-and-aft differential pressure Pv.

Suppose that the rotational speed of motor M is controlled to a maximum speed value during a pump discharge pressure buildup in order to ensure a required braking force in the presence of an abnormality (or a failure) in only one of two front wheel-brake cylinders w/C(FL)-W/C(FR). In such a case, the flow quantity of working fluid flowing in the hydraulic brake circuit becomes maximum (that is, the system maximum flow quantity “Q”). Even under these conditions, the previously-described proper settings (or proper adjustments) of the valve characteristics (i.e., orifice-constriction flow passage areas “A”) of respective inflow valves IN/V(FL, FR) that satisfy the above-mentioned two expressions (a)-(b), balance (1) accurate detection of an abnormality in fluid-pressure deviation ΔP occurring owing to a leak or a fluid-pressure sensor failure and (2) provision of a sufficient braking force created by the normally-operating wheel-brake cylinder by virtue of a pump discharge pressure buildup combined with inflow valves IN/V(FL)-IN/V(FR) whose valve characteristics are properly adjusted or set in the presence of the abnormality in fluid-pressure deviation ΔP (i.e., a hydraulic brake system failure such as a working fluid leak or a fluid-pressure sensor failure).

[Abnormality Detection Control Processing]

(Main Flow)

Referring now to FIG. 3, there is shown the main flow chart illustrating the abnormality detection control processing (the leak detection control routine) executed within the main ECU of in the control apparatus of the first embodiment. In the shown embodiment, the main flow (abnormality detection control processing or abnormality detection for fluid-pressure deviation ΔP) is initiated responsively to a transition from an ON signal state of an ignition switch signal IGN from an ignition switch to an OFF signal state, just after having turned the ignition switch OFF.

At step S101, a decision for an abnormality in fluid-pressure deviation ΔP for each individual front wheel-brake cylinders W/C(FL, FR) is made. Thereafter, the routine proceeds to step S102.

At step S102, a check is made to determine, based on the decision result of step S101, whether an abnormality in fluid-pressure deviation ΔP is present. When the answer to step S102 is in the affirmative (YES), that is, in the presence of an abnormality in fluid-pressure deviation ΔP, the routine proceeds to step S103. Conversely when the answer to step S102 is in the negative (NO), that is, in the absence of an abnormality in fluid-pressure deviation ΔP, the routine proceeds to step S122.

At step S103, an estimate of inflow quantity Qin of each individual wheel-brake cylinder W/C(FL)-W/C(FR), simply, inflow quantity Qin(FL, FR) is calculated, and then the routine proceeds to step S104.

At step S104, outflow quantity Qp of pump P is calculated, and then the routine proceeds to step S105.

At step S105, a check is made to determine whether an abnormality in the hydraulic brake system occurs due to a leak or a fluid-pressure sensor abnormality. Concretely, the outflow-inflow deviation ΔQ (=Qp−Qin) between the pump outflow quantity Qp and inflow quantity Qin(FL, FR) of each individual wheel-brake cylinder W/C(FL, FR) is calculated. Thereafter, a check is made to determine whether the calculated outflow-inflow deviation ΔQ (=Qp−Qin) exceeds the predetermined threshold value Qa. When the answer to step S105 is affirmative (YES), that is, when ΔQ>Qa, it is determined that there is a possibility of a hydraulic-brake-line leak or there is a possibility of a fluid-pressure sensor abnormality, and thus the routine proceeds to step S106. Conversely when the answer to step S105 is negative (NO), that is, when ΔQ≦Qa, it is determined that there is a possibility of an abnormality in fluid-pressure deviation ΔP (or a hydraulic brake system failure) due to a factor except a leak and/or a fluid-pressure sensor abnormality, and thus the routine proceeds to step S120.

At step S106, an elapsed time T (hereinafter is referred to as “outflow-inflow deviation ΔQ abnormal time T”) is measured from a point of time when the outflow-inflow deviation ΔQ (=Qp−Qin) becomes abnormal (i.e., ΔQ>Qa) and thus a transition from a first state defined by ΔQ≦Qa to a second state defined by ΔQ>Qa occurs. Thereafter, the routine proceeds to step S107.

At step S107, a check is made to determine whether the second state (ΔQ>Qa) continues for the predetermined time duration τ after the transition from the first state (ΔQ≦Qa) to the second state (ΔQ>Qa) and thus the outflow-inflow deviation ΔQ abnormal time T becomes greater than the predetermined time duration τ. When the answer to step S107 is affirmative (i.e., T>τ), it is determined that an abnormality in the hydraulic brake system occurs due to a working-fluid leak, and then the routine proceeds to step S108. Conversely when the answer to step S107 is negative (i.e., T≦τ), it is determined that the hydraulic brake system is operating normally, and then the routine proceeds to step S123.

At step S108, the inflow valve IN/V associated with or connected to the abnormal wheel-brake cylinder, which cylinder has a relatively low wheel cylinder pressure due to a leak, is shut off (fully closed), for stopping working-fluid supply to the abnormal wheel-brake cylinder so as to inhibit fluid pressure control of the abnormal wheel-brake cylinder. Thereafter, the routine proceeds to step S109.

At step S109, back-up control is executed in a manner so as to ensure sufficient braking force application to the vehicle by rising a target wheel cylinder pressure P*f of the unfailed, normally-operating wheel-brake cylinder up to a pressure level higher than a normal pressure value used in the absence of the hydraulic brake system abnormality. Thereafter, the routine proceeds to step S110.

At step S110, a warning lamp is turned ON. Thereafter, the routine proceeds to step S111.

At step S111, a check is made to determine whether a warning resolutive condition is satisfied (for example, whether a transition from the abnormal state to the normal state of the hydraulic brake system occurs). When the answer to step S111 is affirmative (YES), for instance, after completion of repairs to the failed portion (the leaking portion) of the hydraulic brake system, the routine proceeds to step S112. Conversely when the answer to step S111 is negative (NO), the routine returns from step S111 back to step S108.

At step S112, the warning lamp is turned OFF. In this manner, one execution cycle of the abnormality detection control processing (the leak detection control routine) terminates.

At step S120, the outflow-inflow deviation ΔQ abnormal time T is cleared. Thereafter, the routine proceeds to step S121.

At step S121, another abnormality diagnosis is made. One execution cycle of the abnormality detection control processing terminates.

At step S122, in a similar manner to step S120, the outflow-inflow deviation ΔQ abnormal time T is cleared. Thereafter, the routine proceeds to step S123.

At step S123, normal-condition brake-by-wire (BBW) control is executed based on the decision result that there is a less possibility of a hydraulic brake system failure such as a leak or a fluid-pressure sensor abnormality. One execution cycle of the abnormality detection control processing terminates.

(Fluid-Pressure Deviation Δp Abnormality Decision Flow)

Referring now to FIG. 4, there is shown the fluid-pressure deviation ΔP abnormality decision subroutine for front-left and front-right wheel-brake fluid-pressure deviations ΔPFL and ΔPFR.

At step S301, first, front-left wheel-brake fluid-pressure deviation ΔPFL is calculated as a deviation (Pt_L−Pw_L) between target front-left wheel cylinder pressure P*fl (=Pt_L) and actual front-left wheel cylinder pressure Pfl (=Pw_L), and at the same time front-right wheel-brake fluid-pressure deviation ΔPFR is calculated as a deviation (Pt_R−Pw_{—}R) between target front-right wheel cylinder pressure P*fr (=Pt_R) and actual front-right wheel cylinder pressure Pfr (=Pw_R). Then, an absolute value |ΔPFL−ΔPFR| of the deviation-to-deviation difference |ΔPFL−ΔPFR| between front-left and front-right wheel-brake fluid-pressure deviations ΔPFL and ΔPFR is calculated. Next, a comparative check is made to determine whether the absolute value |ΔPFL−ΔPFR| exceeds predetermined threshold value k. When the answer to step S301 is affirmative (YES), that is, when |ΔPFL−ΔPFR|≦k, the subroutine proceeds to step S302. Conversely when the answer to step S301 is negative (NO), that is, when |ΔPFL−ΔPFR|≦k, the subroutine proceeds to step S303.

At step S302, it is determined that an abnormality in fluid-pressure deviation ΔP between front-left and front-right wheel-brake cylinders W/C(FL)-W/C(FR) occurs. Thereafter, the subroutine terminates.

At step S303, it is determined that an abnormality in fluid-pressure deviation ΔP between front-left and front-right wheel-brake cylinders W/C(FL)-W/C(FR) does not occur. Thereafter, the subroutine terminates.

(Inflow-Quantity Estimate Arithmetic Calculation Flow)

Referring to FIG. 5, there is shown the arithmetic routine for the estimate of inflow quantity Qin.

At step S501, front-left wheel-cylinder inflow quantity QinFL and front-right wheel-cylinder inflow quantity QinFR are calculated. Thereafter, the subroutine proceeds to step S502.

At step S502, the summed value Qin of front-left and front-right wheel-cylinder inflow quantities QinFL and QinFR is calculated by the expression Qin=QinFL+QinFR. In this manner, one cycle of the inflow quantity Qin arithmetic processing of FIG. 5 terminates.

(Pump Discharge Arithmetic Calculation Flow)

Referring to FIG. 6, there is shown the arithmetic routine for the outflow quantity Qp of working fluid discharged from pump P.

At step S601, a motor speed Nm of motor M is calculated. The subroutine proceeds to step S602.

At step S602, the pump outflow quantity Qp is calculated by the following expression.

Qp=Nm×Vc−Δq

where Nm denotes motor speed of motor M, Vc denotes an inherent outflow discharge rate of pump P, and Δq denotes an inherent leak quantity of working fluid leaked out of pump P. Thereafter, the outflow quantity Qp arithmetic processing of FIG. 6 terminates.

(Each Individual Wheel-Cylinder Inflow Quantity Arithmetic Calculation Flow)

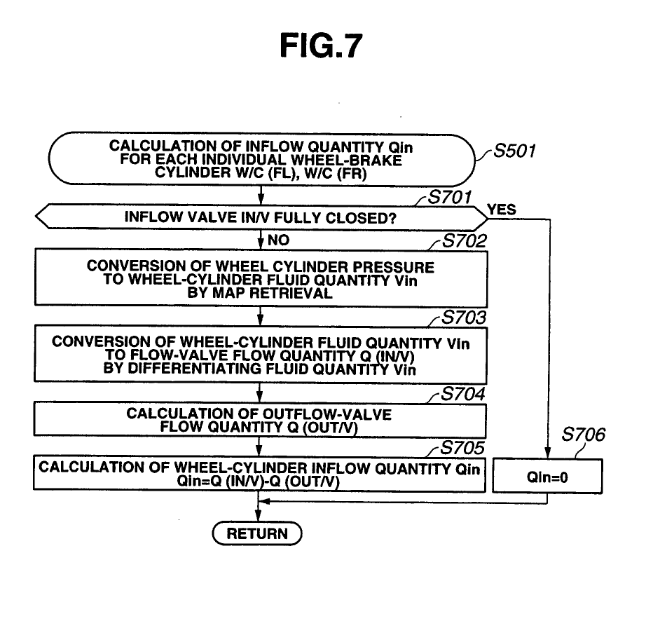

Referring now to FIG. 7, there is shown the inflow quantity arithmetic routine for calculation of front-left and front-right wheel-cylinder inflow quantities QinFL and QinFR.

At step S701, a check is made to determine, based on a drive signal outputted to inflow valve IN/V(FL, FR), whether inflow valve IN/V is fully closed. When the answer to step S701 is affirmative (YES), that is, when the fully-closed state of inflow valve IN/V is detected, the routine proceeds to step S706. Conversely when the answer to step S701 is negative (NO), that is, when the fully-closed state of inflow valve IN/V is not detected, the routine proceeds to step S702.

At step S702, the wheel cylinder pressure (Pw_L, Pw_R) of each individual wheel-brake cylinder W/C(FL)-W/C(FR) is converted into a wheel-cylinder fluid quantity Vin from a preprogrammed pressure-to-fluid-quantity conversion map. Thereafter, step S703 occurs.

At step S703, an inflow-valve flow quantity Q(IN/V) is calculated by differentiating the wheel-cylinder fluid quantity Vin, obtained by the above-mentioned pressure-to-fluid-quantity conversion. Thereafter, step S704 occurs.

At step S704, an outflow-valve flow quantity Q(OUT/V) is calculated based on a drive signal outputted to outflow valve OUT/V(FL, FR) and the wheel cylinder pressure (Pw_L, Pw_R). Thereafter, step S705 occurs.

At step S705, wheel-cylinder inflow quantity Qin is calculated based on the calculated inflow-valve flow quantity Q(IN/V) and the calculated outflow-valve flow quantity Q(OUT/V), from the following expression.

Qin=Q(IN/V)−Q(OUT/V)

At step S706, wheel-cylinder inflow quantity Qin is set to “0”, that is, Qin=0. In this manner, one cycle of each individual front wheel-cylinder inflow quantity arithmetic processing of FIG. 7 terminates.

[Time Chart During Abnormality Detection Control]

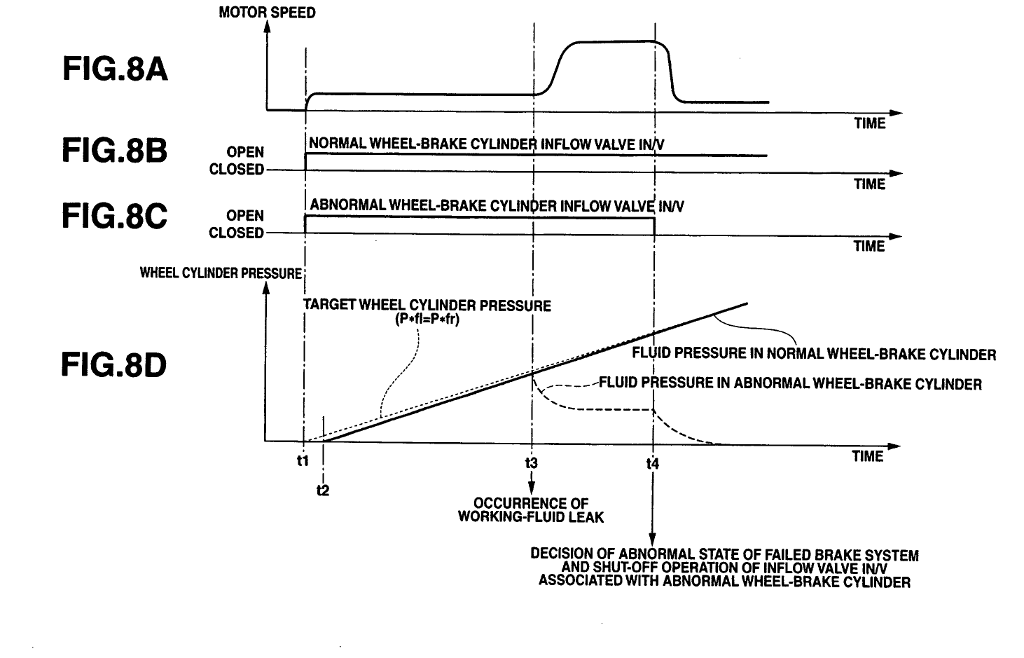

Referring now to FIGS. 8A-8D, there are shown the time charts for abnormality detection control (or leak detection control). The solid line shown in FIG. 8A indicates a change in motor speed Nm of motor M. The solid line shown in FIG. 8B indicates a change in the valve opening of inflow valve IN/V associated with the normally-operating wheel-brake cylinder, whereas the solid line shown in FIG. 8C indicates a change in the valve opening of inflow valve IN/V associated with the abnormal (or failed) wheel-brake cylinder. The fine broken line shown in FIG. 8D indicates a change in target wheel cylinder pressure for each individual wheel-brake cylinder W/C(FL)-W/C(FR), in the case of the same wheel cylinder pressure (P*fl=P*fr) for front-left and front-right road wheels FL-FR. The heavy solid line shown in FIG. 8D indicates a change in the actual wheel cylinder pressure in the normally-operating wheel-brake cylinder, whereas the heavy broken line shown in FIG. 8D indicates a change in the actual wheel cylinder pressure in the abnormal (or failed) wheel-brake cylinder.

(Time t1)

As seen in FIG. 8A, motor M begins to rotate at the time t1. As seen in FIGS. 8B-8D, inflow valve IN/V associated with the normally-operating wheel-brake cylinder and inflow valve IN/V associated with the abnormal wheel-brake cylinder are shifted from their closed states to their open states at the time t1, owing to a build up of target wheel cylinder pressure P*fl (=P*fr).

(Time t2)

The actual wheel cylinder pressures Pfl and Pfr begin to rise at the time t2 with a slight time lag from the time t1.

(Time t3)

On the one hand, the actual wheel cylinder pressure of the abnormal wheel-brake cylinder, associated with an abnormal or failed hydraulic-brake system having a possibility of a working-fluid leak (e.g., a brake-fluid leak from the wheel-cylinder brake line), begins to drop from the time t3, at which the system failure occurs (see the pressure drop indicated by the heavy broken line in FIG. 8D). On the other hand, the actual wheel cylinder pressure of the normally-operating wheel-brake cylinder associated with a normal or unfailed hydraulic-brake system having a less possibility of a leak, tends to rise continuously after the time t3 (see the continuous pressure rise indicated by the heavy solid line in FIG. 8D). As can be seen in FIG. 8A, as a result of working-fluid pressure feedback control, motor speed Nm tends to increase (see the motor speed increase during the time period from the time t3 to the time t4 in FIG. 8A).

(Time t4)

At the time t4, the abnormal state of the failed hydraulic-brake system (including a failure in the wheel-brake cylinder itself) is detected or decided, and thus the inflow valve IN/V, associated with the abnormal (malfunctioning) wheel-brake cylinder included in the abnormal (failed) hydraulic-brake system, is shut off (fully closed). After the time t4, the working-fluid pressure feedback (F/B) control mode is switched from two wheel-brake pressure F/B control to one wheel-brake pressure F/B control, and thus motor speed Nm is adjusted or controlled to a target motor speed value programmed for the one wheel-brake pressure F/B control.

[Effects of First Embodiment]

(1) The brake control apparatus of the first embodiment is comprised of a plurality of wheel-brake cylinders W/C(FL) and W/C(FR) provided at respective road wheels FL-FR, a hydraulic unit HU configured to regulate an actual wheel cylinder pressure Pf in each of wheel-brake cylinders W/C(FL, FR), a controller 1 (control means), such as a main ECU 300 and/or a sub-ECU 100, configured to calculate a target wheel cylinder pressure P*f of each of wheel-brake cylinders W/C(FL, FR) based on a driver's manipulated variable (e.g., at least a sensor signal S from stroke sensor S/Sen) of a brake pedal BP and to control the hydraulic unit HU responsively to the calculated target wheel cylinder pressures P*fl-P*fr, a fluid-pressure source (a pump P) installed in the hydraulic unit HU, fluid-pressure sensors (fluid-pressure sensor means) WC/Sen(FL)-WC/Sen(FR) configured to detect the actual wheel cylinder pressures Pfl-Pfr, and inflow valves IN/V(FL) and IN/V(FR), each of which inflow valves is disposed between the pump P and the associated wheel-brake cylinder and has a predetermined flow passage area A. The controller 1 includes a fluid-pressure deviation calculation circuit (a fluid-pressure deviation calculation means or a fluid-pressure deviation arithmetic-calculation-and-logic means), which is configured to calculate a fluid-pressure deviation ΔP(FL, FR) between the target wheel cylinder pressure P*f and the actual wheel cylinder pressure Pf, for each of wheel-brake cylinders W/C(FL, FR), and to compare the calculated fluid-pressure deviation ΔP(FL, FR) to a predetermined threshold value k. The fluid-pressure deviation calculation means determines that an abnormality in fluid-pressure deviation ΔP(FL, FR) occurs, when the calculated fluid-pressure deviation ΔP(FL, FR) exceeds the predetermined threshold value k (see step S101). When the abnormality in fluid-pressure deviation ΔP(FL, FR) is detected or decided, the controller 1 stops or inhibits working-fluid supply from the fluid-pressure source (pump P) to the wheel-brake cylinder having the abnormality in fluid-pressure deviation ΔP(FL, FR) (i.e., the wheel-brake cylinder having fluid-pressure deviation ΔP (>k) exceeding the predetermined threshold value k).

As a result of this, it is possible to ensure a sufficient braking force, while reducing or suppressing the amount of working fluid leaked out from the abnormal (failed) hydraulic-brake system.

(1-1) In addition to the above-mentioned fluid-pressure deviation calculation means (see step S101), the controller 1 further comprises a deviation-to-deviation difference calculation circuit (a deviation-to-deviation difference calculation means) (see step S301) configured to calculate a difference (e.g., ΔPFL−ΔPFR) between the fluid-pressure deviation (e.g., ΔPFL) of one (e.g., W/C(FL)) of wheel-brake cylinders W/C(FL, FR) and the fluid-pressure deviation (e.g., ΔPFR) of the other wheel-brake cylinder (e.g., W/C(FR)). It is possible to more certainly decide the presence or absence of the hydraulic-brake system abnormality by comparison of the calculated deviation-to-deviation difference (e.g., ΔPFL−ΔPFR) with the predetermined threshold value k. By way of comparison of the actual wheel cylinder pressure of a first one of a plurality of road wheels FL-FR and the actual wheel cylinder pressure of the second road wheel, it is possible to accurately specify or determine which of the hydraulic-brake systems is leaking (failed or abnormal) or which of the wheel-brake cylinders is leaking (failed or abnormal).

(1-4) Hydraulic unit HU has inflow valves IN/V(FL, FR) installed therein and connected to the respective wheel-brake cylinders. The controller 1 (main ECU 300 and/or sub-ECU 100) is configured to fully close (shut off) the inflow valve IN/V associated with the abnormal wheel-brake cylinder having the abnormality in fluid-pressure deviation ΔP(FL, FR), for stopping or inhibiting working-fluid supply from the fluid-pressure source (pump P) to the abnormal wheel-brake cylinder having the abnormality in fluid-pressure deviation ΔP(FL, FR). Therefore, it is possible to certainly avoid or prevent a further leak from the leaking portion of the failed hydraulic brake system (or the abnormal wheel-brake cylinder) having a possibility of a working-fluid leak.

(1-5) The controller 1 (main ECU 300 and/or sub-ECU 100) is further configured to increase an outflow quantity Qp of working fluid discharged from pump P, when the hydraulic brake system abnormality (the abnormality in fluid-pressure deviation ΔP), arising from a working-fluid leak, is detected or decided. Therefore, it is possible to ensure a sufficient braking force by building up the wheel cylinder pressure in the normally-operating wheel-brake cylinder.

(1-6) Assuming that a hydraulic system maximum flow quantity of working fluid, supplied from pump P into hydraulic unit HU and regulated by hydraulic unit HU, is denoted by “Q”, an inflow-valve fore-and-aft differential pressure between a fluid pressure upstream of inflow valve IN/V and a fluid pressure downstream of the same inflow valve IN/V is denoted by “Pv”, a density of working fluid is denoted by “ρ”, a flow coefficient (a capacity coefficient) of inflow valve IN/V is denoted by “C”, a fore-and-aft differential pressure (an upstream-and-downstream differential pressure) of inflow valve IN/V associated with a failed (or abnormal or malfunctioning) wheel-brake cylinder (having an abnormality in fluid-pressure deviation ΔP) is regarded as to be equal to a left-and-right wheel-cylinder pressure difference used or needed to detect an abnormality in the hydraulic brake system such as a working-fluid leak or a fluid-pressure sensor failure and denoted by “Pv1”, and a fore-and-aft differential pressure (an upstream-and-downstream differential pressure) of the inflow valve IN/V associated with the failed (or abnormal or malfunctioning) wheel-brake cylinder is also regarded as to be equal to a necessary wheel cylinder pressure required for a normally-operating wheel-brake cylinder (not having an abnormality in fluid-pressure deviation ΔP) for ensuring a braking force in the presence of an abnormality in the hydraulic brake system (an abnormality in fluid-pressure deviation ΔP) and denoted by “Pv2”. An orifice-constriction flow passage area “A” of the orifice portion of each of inflow valves IN/V(FL, FR) is set or adjusted to satisfy the following two mathematical expressions.

Pv=(Q²·ρ)/(2·A²·C²) (a)

Pv(max)≧(Pv1,Pv2) (b)

The above-mentioned expression (b) means or defines that a higher one MAX(Pv1, Pv2) of the two fore-and-aft differential pressures Pv1 and Pv2is selected as the inflow-valve fore-and-aft differential pressure Pv.

By the previously-described proper settings (or proper adjustments) of the valve characteristics (i.e., orifice-constriction flow passage areas “A”) of respective inflow valves IN/V(FL, FR) that satisfy the above-mentioned two expressions (a)-(b), it is possible to balance (1) the fore-and-aft differential pressure Pv1 of inflow valve IN/V (associated with the abnormal wheel-brake cylinder) needed for accurate abnormality detection and (2) the fore-and-aft differential pressure Pv2 of inflow valve IN/V (associated with the abnormal wheel-brake cylinder) needed for provision of a sufficient braking force created by the normally-operating wheel-brake cylinder by virtue of a pump discharge pressure buildup in the presence of the abnormality in fluid-pressure deviation ΔP (i.e., a hydraulic brake system failure such as a working fluid leak or a fluid-pressure sensor failure).

(1-7) In the first embodiment shown in FIGS. 1-8D, a single hydraulic unit HU, common to front-left and front-right hydraulic wheel brakes, is provided for two-wheel brake-by-wire control for front road wheels FL-FR of a four-wheeled vehicle. A single fluid pressure source (i.e., pump P) is installed in hydraulic unit HU, and two wheel-brake cylinders W/C are provided for the respective front road wheels FL-FR. In lieu thereof, a single pump-equipped hydraulic unit HU, common to rear-left and rear-right hydraulic wheel brakes, may be provided for brake-by-wire (BBW) control for rear road wheels RL-RR of a four-wheeled vehicle.

(2-7) Additionally, the main flow (abnormality detection control processing or abnormality detection processing for fluid-pressure deviation ΔP) is initiated and executed responsively to a transition from an ON state of an ignition switch signal IGN from an ignition switch to an OFF state, just after having turned the ignition switch OFF. Thus, it is possible to certainly perform abnormality detection for fluid-pressure deviation ΔP, before the control system (the main ECU and the sub-ECU) has been completely shut down just after having turned the ignition switch OFF.

As set forth above, it is possible to provide the previously-discussed effects (1) to (1-7), and (2-7), in a four-wheeled vehicle in which only the front road wheels FL-FR (or only the rear road wheels RL-RR) are subjected to BBW control via the single hydraulic unit HU, while braking forces applied to the other road wheels RL-RR (or FL-FR) are adjusted by means of dynamo-electric brakes (electric-operated brake calipers 7, 7).

### Second Embodiment

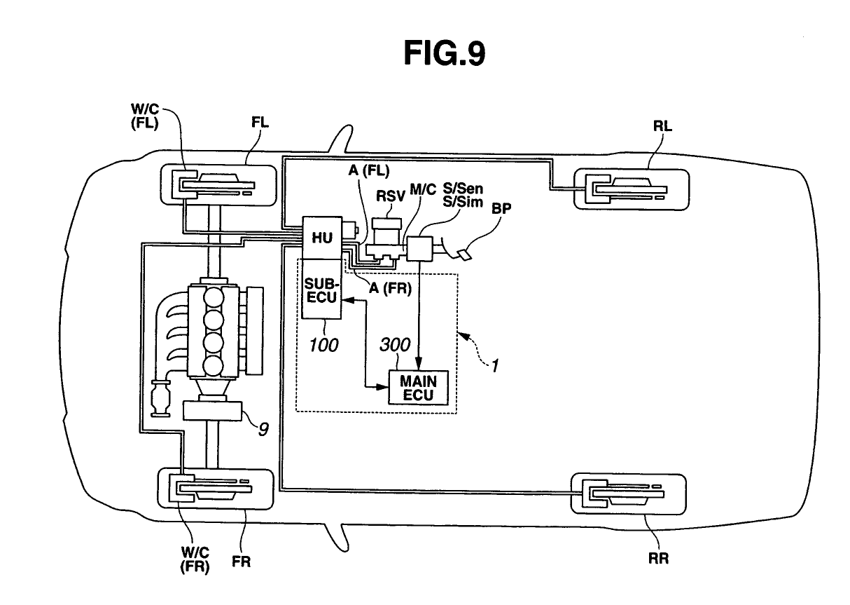

Referring now to FIGS. 9-14, there is shown the brake control apparatus of the second embodiment. The fundamental concept for abnormality detection (or leak detection) of the second embodiment is the same as the first embodiment. The previously-discussed first embodiment is exemplified in a two-wheel brake-by-wire system equipped brake device in a four-wheeled vehicle with two front hydraulic wheel brakes and two rear dynamo-electric brakes, for BBW control for only front road wheels FL-FR. On the other hand, the second embodiment is exemplified in a four-wheel brake-by-wire system equipped brake device in a four-wheeled vehicle with two rear hydraulic wheel brakes as well as two front hydraulic wheel brakes.

[Brake System Configuration]

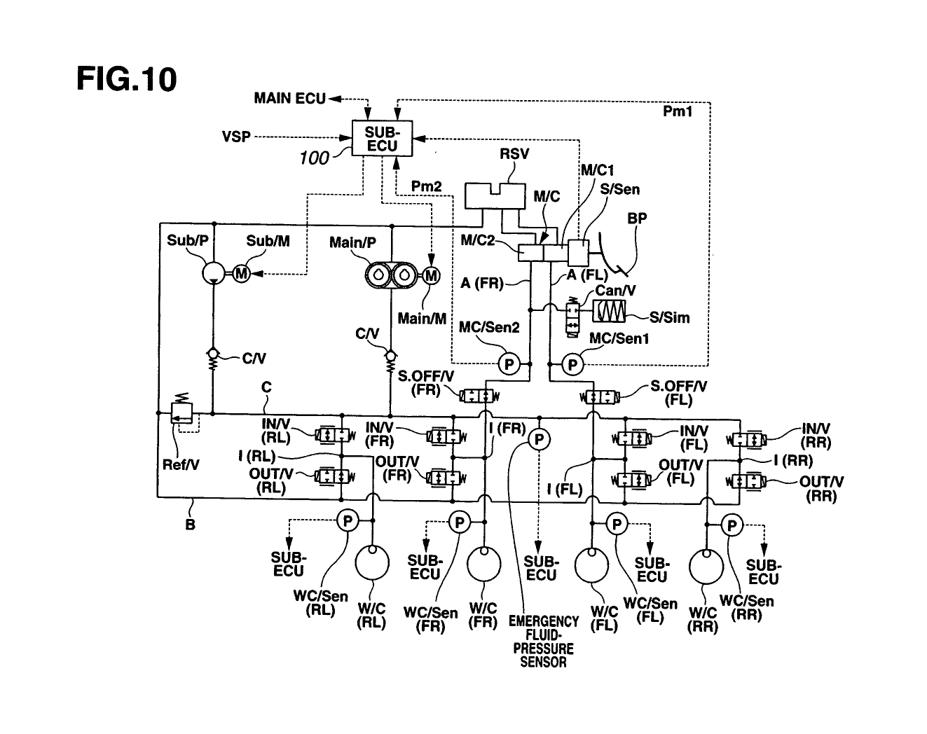

FIG. 9 shows the brake control system configuration of the brake control apparatus of the second embodiment. FIG. 10 shows a hydraulic circuit diagram of the common hydraulic unit HU employed in the brake control apparatus of the second embodiment for regulating four working fluid pressures Pfl, Pfr, Prl, and Prr for four wheel-brake cylinders W/C(FL)-W/C(RR). Master cylinder M/C (a brake fluid-pressure device) is a tandem master cylinder with two pistons set in tandem. The first port of master cylinder M/C is connected via a fluid line (a manual brake circuit) A(FL) to front-left wheel-brake cylinder W/C(FL), whereas the second port of master cylinder M/C is connected via a fluid line (a manual brake circuit) A(FR) to front-right wheel-brake cylinder W/C(FR). The primary pressure chamber (a first master cylinder M/C1) and the secondary pressure chamber (a second master cylinder M/C2) of master cylinder M/C are connected to master-cylinder reservoir RSV. Operations of electromagnetic valves employed in hydraulic unit HU are controlled by means of sub-ECU 100. As a fluid pressure source, a main pump Main/P and a sub-pump (an emergency pump) Sub/P are provided in parallel with each other. Main pump Main/P is driven by a main motor Main/M responsively to a command signal from sub-ECU 100. Sub-pump (emergency pump) Sub/P is driven by a sub-motor Sub/M responsively to a command signal from sub-ECU 100.

First shutoff valve S.OFF/V(FL) is comprised of a normally-open electromagnetic valve, and fluidly disposed in fluid line A(FL) for establishing or blocking fluid communication between first master cylinder M/C1 and front-left wheel-brake cylinder W/C(FL). Second shutoff valve S.OFF/V(FR) is comprised of a normally-open electromagnetic valve, and fluidly disposed in fluid line A(FR) for establishing or blocking fluid communication between second master cylinder M/C2 and front-right wheel-brake cylinder W/C(FR).

Stroke simulator S/Sim is connected via a cancel valve Can/V (a normally-closed electromagnetic two-port two-position (ON/OFF) valve) to either one of the manual brake circuits A(FL)-A(FR) and located between master cylinder M/C and shutoff valve S.OFF/V(FL, FR).

When depressing brake pedal BP with the shutoff valve S.OFF/V(FL, FR) closed and the cancel valve Can/V opened (energized), working fluid in master cylinder M/C is introduced into stroke simulator S/Sim so as to ensure a stroke of brake pedal BP.

The discharge side (a main pump outlet) of main pump Main/P and the discharge side (a sub-pump outlet) of sub-pump Sub/P are connected to a pressure buildup circuit C, and also connected via four joining points I(FL), I(FR), I(RL) and I(RR) to respective wheel-brake cylinders W/C(FL)-W/C(RR). On the other hand, the suction side (a main pump inlet) of main pump Main/P and the suction side (a sub-pump inlet) of sub-pump Sub/P are connected to a pressure reduction circuit B.

Front-left, front-right, rear-left, and rear-right inflow valves (normally-closed proportional control valves) IN/V(FL)-IN/V(RR) are fluidly disposed in pressure buildup circuit C, for establishing or blocking fluid communication between (1) each pump (Main/P, Sub/P) and (2) each individual wheel-brake cylinder W/C(FL)-W/C(RR).

Four wheel-brake cylinders W/C(FL)-W/C(RR) are also connected via respective joining points I(FL)-I(RR) to pressure reduction circuit B. Front-left, front-right, rear-left, and rear-right outflow valves (normally-closed proportional control valves) OUT/V(FL)-OUT/V(RR) are fluidly disposed in pressure reduction circuit B, for establishing or blocking fluid communication between (1) master-cylinder reservoir RSV and (2) each individual wheel-brake cylinder W/C (FL)-W/C (RR).

Backflow-prevention check valves C/V, C/V are respectively disposed in the discharge side (a main pump discharge line) of main pump Main/P and the discharge side (a sub-pump discharge line) of sub-pump Sub/P, for preventing back-flow of working fluid from pressure buildup circuit C to pressure reduction circuit B via respective pumps Main/P and Sub/P. Pressure buildup circuit C and pressure reduction circuit B are connected to each other via relief valve Ref/V, for relieving working fluid from pressure buildup circuit C to pressure reduction circuit B via relief valve Ref/V opened when the working-fluid pressure in pressure buildup circuit C exceeds a specified pressure value (a relief-valve set pressure).

First master-cylinder pressure sensor MC/Sen1 is provided or screwed into manual brake circuit A(FL) interconnecting first shutoff valve S.OFF/V(FL) and the first port of master cylinder M/C, for detecting a master-cylinder pressure Pm1 and for generating a signal indicative of the detected master-cylinder pressure Pm1 to main ECU 300. Similarly, second master-cylinder pressure sensor MC/Sen2 is provided or screwed into manual brake circuit A(FR) interconnecting second shutoff valve S.OFF/V(FR) and the second port of master cylinder M/C, for detecting a master-cylinder pressure Pm2 and for generating a signal indicative of the detected master-cylinder pressure Pm2 to main ECU 300. Front-left, front-right, rear-left, and rear-right wheel-cylinder pressure sensors WC/Sen(FL)-WC/Sen(RR) are provided for each individual wheel-brake cylinder W/C(FL)-W/C(RR), for detecting actual front-left, front-right, rear-left, and rear-right wheel cylinder pressures Pfl-Prr. Stroke sensor S/Sen is provided at master cylinder M/C, for generating a stroke signal S substantially corresponding to an amount of depression of brake pedal BP.

Signals indicative of the detected values Pm1-Pm2, Pfl-Prr, and S are generated from the respective sensors MC/Sen1-MC/Sen2, WC/Sen(FL)-WC/Sen(RR), and S/Sen to sub-ECU 100.

The processor of main ECU 300, electrically connected to sub-ECU 100, calculates, based on the sensor signals, target wheel cylinder pressures P*fl-P*rr. Responsively to command signals generated from main ECU 300 to sub-ECU 100, operations of main motor Main/M, sub-motor Sub/M, inflow valves IN/V(FL)-IN/V(RR), and outflow valves OUT/V(FL)-OUT/V(RR) are controlled. During normal braking operation via the BBW system, shutoff valves S.OFF/V(FL)-S.OFF/V(FR) are activated and kept closed and cancel valve Can/V is activated and kept open.

Sub-ECU 100 compares the actual wheel cylinder pressures Pfl-Prr with the respective target wheel cylinder pressures P*fl-P*rr to calculate four wheel-brake fluid-pressure deviations ΔPFL−ΔPRR. In the case of the actual wheel cylinder pressure abnormally deviated from the target wheel cylinder pressure, in other words, in the presence of an abnormality in wheel-brake fluid-pressure deviation ΔP, sub-ECU 100 generates an abnormal signal to a warning lamp to turn the warning lamp ON. The input interface of sub-ECU 100 receives a vehicle speed sensor signal (or wheel speed sensor signals), indicative of vehicle speed VSP (or wheel speeds), for determining whether the vehicle is conditioned in a running state or in a stopped state.

[Braking Control]

(During Pressure Buildup at BBW Normal Braking Mode)

During normal braking at a pressure buildup mode via the four-wheel BBW system, cancel valve Can/V is kept open and shutoff valves S.OFF/V(FL)-S.OFF/V(FR) are kept closed. Under these conditions, the depression of brake pedal BP by the driver is detected by stroke sensor S/Sen. Sub-ECU 100 calculates target wheel cylinder pressures P*fl-P*rr for each individual wheel-brake cylinder W/C(FL)-W/C(rr), based on the detected values (latest up-to-date information concerning sensor signals). Either main motor Main/M or sub-motor Sub/M is driven responsively to a command signal from sub-ECU 100, for applying a pump discharge pressure to pressure buildup circuit C. Then, inflow valves IN/V(FL)-IN/V(RR) associated with respective wheel-brake cylinders W/C(FL)-W/C(RR) are operated depending on the calculated target wheel cylinder pressures P*fl-P*rr, for supplying the regulated fluid pressures to the respective wheel-brake cylinders so as to provide a required braking force.

(During Pressure Reduction)

During normal braking at a pressure reduction mode, responsively to command signals from sub-ECU 100 to each individual outflow valve OUT/V(FL)-OUT/V(RR), these outflow valves are driven and kept open, for exhausting working fluid from each individual wheel-brake cylinder W/C(FL)-W/C(RR) via pressure reduction circuit B to reservoir RSV.

(During Pressure Hold)

During normal braking at a pressure hold mode, each of inflow valves IN/V(FL)-IN/V(RR) and each of outflow valves OUT/V(FL)-OUT/V(RR) are kept closed, for blocking fluid communication between each wheel-brake cylinder WC(FL)-W/C(RR) and pressure buildup circuit C and for blocking fluid communication between each wheel-brake cylinder WC(FL)-W/C(RR) and pressure reduction circuit B.

[Manual Brake in Presence of BBW System Failure]

When the operating mode of the four-wheel BBW system equipped brake control apparatus has been switched to a manual brake mode owing to a functional failure of the four-wheel BBW system, normally-open shutoff valves S.OFF/V(FL)-S.OFF/V(RR) become kept open, normally-closed inflow valves IN/V(FL)-IN/V(RR) become kept closed, and normally-closed outflow valves OUT/V(FL)-OUT/V(RR) become kept closed. As a result of this, fluid communication between master cylinder M/C and each of front wheel-brake cylinders W/C(FL)-W/C(FR) is established and thus front wheel-brake cylinders W/C(FL)-W/C(FR) become conditioned in their master-cylinder pressure application states. In this manner, the manual brake mode can be achieved or ensured.

[Abnormality Detection Control in Second Embodiment]

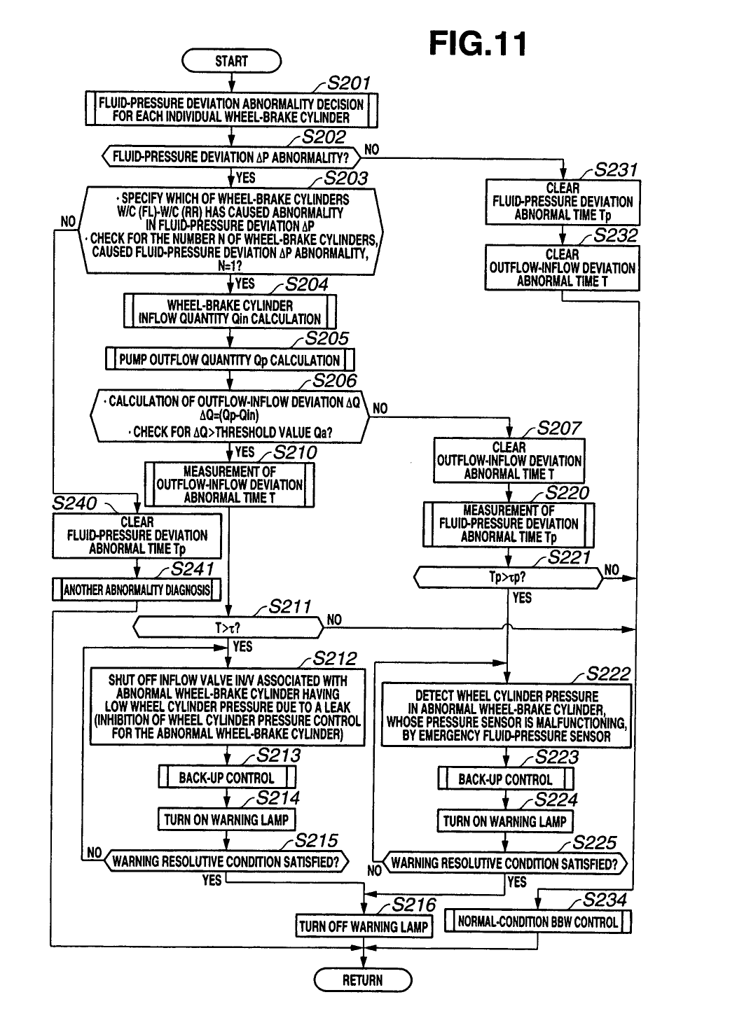

Basically, the abnormality detection control of the second embodiment is similar to that of the first embodiment. However, the second embodiment slightly differs from the first embodiment, in that all of four wheel cylinder pressures Pfl-Prr are built up by a single pump (either the main pump or the sub-pump). Generally, there is a less possibility of a plurality of leaks simultaneously occurring in the hydraulic brake circuit. Thus, when two or more wheel-brake cylinder pressure abnormalities are detected, the processor of the ECU determines that these abnormalities are occurring owing to a factor except a leak and/or a fluid-pressure sensor failure. In such a case, the ECU interrupt or inhibit abnormality detection control (see the flow S203→S240→S241 in FIG. 11).

Additionally, the brake control apparatus of the second embodiment determines that a wheel-brake cylinder leak or a fluid-pressure sensor failure is occurring, when a remarkable deviation of the actual wheel cylinder pressure of a certain wheel-brake cylinder from its target wheel cylinder pressure continues for a long time, even under a condition where there is a less outflow-inflow deviation ΔQ (=Qp−Qin) between pump outflow quantity Qp and wheel-brake cylinder inflow quantity Qin (see step S221 in FIG. 11). In such a case, the wheel cylinder pressure in the abnormal wheel-brake cylinder is measured or detected by means of an emergency fluid-pressure sensor, which is provided or screwed into pressure buildup circuit C (see step S222 in FIG. 11).

[Abnormality Detection Control Processing in Second Embodiment]

(Main Flow)

Referring now to FIG. 11, there is shown the main flow chart illustrating the abnormality detection control processing executed within the main ECU of in the control apparatus of the second embodiment. In the second embodiment, the main flow (abnormality detection control processing or abnormality detection for fluid-pressure deviation ΔP) is initiated responsively to a transition from an ON state of an ignition switch signal IGN to an OFF state, just after having turned the ignition switch OFF.

At step S201, a decision for an abnormality in fluid-pressure deviation ΔP (exactly, ΔPFL, ΔPFR, ΔPRL, ΔPRR) for each individual wheel-brake cylinder W/C(FL, FR, RL, RR) is made. Thereafter, the routine proceeds to step S202.

At step S202, a check is made to determine, based on the decision result of step S201, whether an abnormality in fluid-pressure deviation ΔP is present. More concretely, an elapsed time (hereinafter is referred to as “fluid-pressure deviation ΔP abnormal time Tp”) is measured from a point of time when the fluid-pressure deviation ΔP exceeds a predetermined threshold value k and thus an abnormality in fluid-pressure deviation ΔP has been decided (i.e., ΔP>k). A check is made to determine whether the state defined by ΔP>k continues for a predetermined time duration τp after the transition from the state defined by ΔP≦k to the state defined by ΔP>k and thus the fluid-pressure deviation ΔP abnormal time Tp becomes greater than the predetermined time duration Tp. When the answer to step S202 is affirmative (YES), that is, in the presence of an abnormality in fluid-pressure deviation ΔP, the routine proceeds to step S203. Conversely when the answer to step S202 is negative (NO), that is, in the absence of an abnormality in fluid-pressure deviation ΔP, the routine proceeds to step S231.

Step S203 determines or specifies which of wheel-brake cylinders W/C(FL)-W/C(RR) has caused the abnormality in fluid-pressure deviation ΔP by comparing each of the calculated four wheel-brake fluid-pressure deviations ΔPFL−ΔPRR with the predetermined threshold value k. Thereafter, a check is made to determine whether the number N of the wheel-brake cylinders, caused the abnormality in fluid-pressure deviation ΔP, is “1”. When the answer to step S203 is affirmative (YES), that is, when the number of the abnormal wheel-brake cylinders is “1”, the routine proceeds to step S204. Conversely when the answer to step S203 is negative (NO), that is, when the number of the abnormal wheel-brake cylinders is “2” or more, the routine proceeds to step S240.

At step S204, an estimate of inflow quantity Qin of each individual wheel-brake cylinder W/C(FL)-W/C(RR), simply, inflow quantity Qin(FL, FR, RL, RR) is calculated, and then the routine proceeds to step S205.

At step S205, pump outflow quantity Qp is calculated, and then the routine proceeds to step S206.

At step S206, a check is made to determine whether an abnormality in the hydraulic brake system occurs due to a leak or a fluid-pressure sensor abnormality. Concretely, the outflow-inflow deviation ΔQ (=Qp−Qin) between the pump outflow quantity Qp and wheel-brake cylinder inflow quantity Qin(FL, FR, RL, RR) of each individual wheel-brake cylinder W/C(FL, FR, RL, RR) is calculated. Thereafter, a check is made to determine whether the calculated outflow-inflow deviation ΔQ (=Qp−Qin) exceeds the predetermined threshold value Qa. When the answer to step S206 is affirmative (YES), that is, when ΔQ>Qa, it is determined that there is a possibility of a hydraulic-brake-line leak (or a fluid-pressure sensor abnormality), and thus the routine proceeds to step S210. Conversely when the answer to step S206 is negative (NO), that is, when ΔQ≦Qa, it is determined that there is a possibility of an abnormality in fluid-pressure deviation ΔP (or a hydraulic brake system failure) due to a factor except a leak and/or a fluid-pressure sensor abnormality, and thus the routine proceeds to step S207.

At step S207, an outflow-inflow deviation ΔQ abnormal time T (described later in step S210) is cleared. Thereafter, the routine proceeds to step S220.

At step S210, elapsed time T (hereinafter is referred to as “outflow-inflow deviation ΔQ abnormal time T”) is measured from a point of time when the outflow-inflow deviation ΔQ (=Qp−Qin) becomes abnormal (i.e., ΔQ>Qa) and thus a transition from a first state defined by ΔQ≦Qa to a second state defined by ΔQ>Qa occurs. Thereafter, the routine proceeds to step S211.

At step S211, a check is made to determine whether the second state (ΔQ>Qa) continues for the predetermined time duration τ after the transition from the first state (ΔQ≦Qa) to the second state (ΔQ>Qa) and thus the outflow-inflow deviation ΔQ abnormal time T becomes greater than the predetermined time duration τ. When the answer to step S211 is affirmative (i.e., T>τ), it is determined that an abnormality in the hydraulic brake system occurs due to a leak, and then the routine proceeds to step S212. Conversely when the answer to step S211 is negative (i.e., T≦τ), it is determined that the hydraulic brake system is operating normally, and then the routine proceeds to step S234.

At step S212, the inflow valve IN/V associated with or connected to the abnormal wheel-brake cylinder of a relatively low wheel cylinder pressure is shut off (fully closed), for stopping working-fluid supply to the abnormal wheel-brake cylinder so as to inhibit fluid pressure control of the abnormal wheel-brake cylinder. Thereafter, the routine proceeds to step S213.

At step S213, back-up control is executed in a manner so as to ensure sufficient braking force application to the vehicle by rising a target wheel cylinder pressure P* of the unfailed, normally-operating wheel-brake cylinder up to a pressure level higher than a normal pressure value used in the absence of the hydraulic brake system abnormality. Thereafter, the routine proceeds to step S214.

At step S214, a warning lamp is turned ON. Thereafter, the routine proceeds to step S215.

At step S215, a check is made to determine whether a warning resolutive condition is satisfied (for example, whether a transition from the abnormal state, arising from a leak, to the normal state of the hydraulic brake system occurs). When the answer to step S215 is affirmative (YES), for instance, after completion of repairs to the failed portion (the leaking portion) of the hydraulic brake system, the routine proceeds to step S216. Conversely when the answer to step S215 is negative (NO), the routine returns from step S215 back to step S212.

At step S216, the warning lamp is turned OFF. In this manner, one execution cycle of the abnormality detection control processing terminates.

At step S220, fluid-pressure deviation ΔP abnormal time Tp is measured from the time when the fluid-pressure deviation ΔP becomes abnormal (i.e., ΔP>k). Thereafter, the routine proceeds to step S221.

At step S221, a check is made to determine whether the state defined by ΔP>k continues for the predetermined time duration τp after the transition from the state defined by ΔP≦k to the state defined by ΔP>k and thus the fluid-pressure deviation ΔP abnormal time τp becomes greater than the predetermined time duration τp (i.e., Tp>τp). When the answer to step S221 is affirmative (YES), it is determined that the abnormality in fluid-pressure deviation ΔP occurs due to a fluid-pressure sensor abnormality (exactly, due to an abnormality or a failure in the wheel-cylinder pressure sensor WC/Sen associated with the abnormal wheel-brake cylinder) rather than a leak and thus the routine proceeds to step S222. Conversely when the answer to step S221 is negative (NO), the routine proceeds to step S234.

At step S222, the wheel cylinder pressure in the abnormal wheel-brake cylinder, at which the fluid-pressure sensor abnormality is occurring (Tp>τp), is measured or detected or estimated by means of an emergency fluid-pressure sensor, which is operating normally and provided or screwed into pressure buildup circuit C. Thereafter, the routine proceeds to step S223.

At step S223, back-up control is executed in a manner so as to adjust the target wheel cylinder pressure of the abnormal wheel-brake cylinder, at which the fluid-pressure sensor abnormality is occurring (Tp>τp), to the same target value as the target wheel cylinder pressure of the normal wheel-brake cylinder, at which the fluid-pressure sensor abnormality does not occur (Tp≦τp). Thereafter, the routine proceeds to step S224.

At step S224, a warning lamp is turned ON. Thereafter, the routine proceeds to step S225.

At step S225, a check is made to determine whether a warning resolutive condition is satisfied (for example, whether a transition from the abnormal state, arising from a fluid-pressure sensor abnormality, to the normal state of the hydraulic brake system occurs). When the answer to step S225 is affirmative (YES), for instance, after completion of repairs to the failed fluid-pressure sensor of the hydraulic brake system, the routine proceeds to step S216. Conversely when the answer to step S225 is negative (NO), the routine returns from step S225 back to step S222.

At step S231, fluid-pressure deviation ΔP abnormal time Tp is cleared. Thereafter, the routine proceeds to step S232.

At step S232, outflow-inflow deviation ΔQ abnormal time T is cleared. Thereafter, the routine proceeds to step S234.

At step S234, normal-condition brake-by-wire (BBW) control is executed based on the decision result that there is a less possibility of a hydraulic brake system failure such as a leak and a fluid-pressure sensor abnormality. One execution cycle of the abnormality detection control processing terminates.

At step S240, fluid-pressure deviation ΔP abnormal time Tp is cleared. Thereafter, the routine proceeds to step S221.

At step S241, another abnormality diagnosis is made. One execution cycle of the abnormality detection control processing terminates.

(Fluid-Pressure Deviation ΔP Abnormality Decision Flow in Second Embodiment)

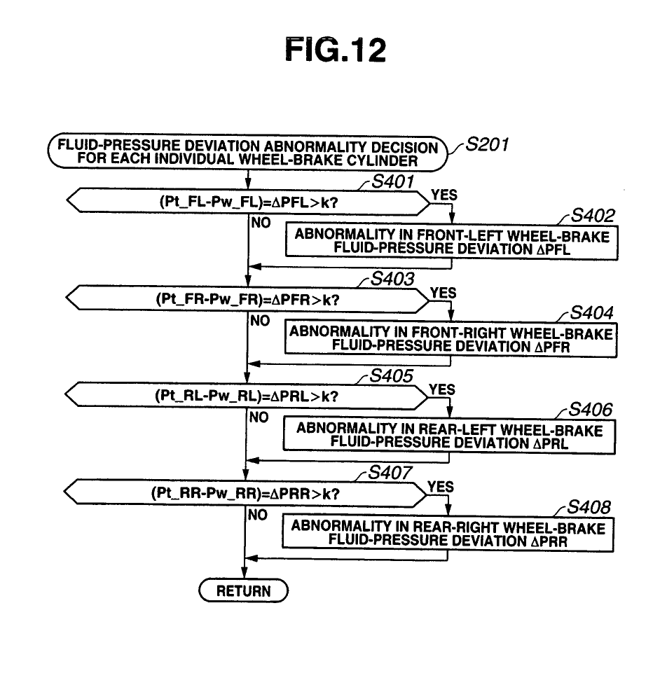

Referring now to FIG. 12, there is shown the fluid-pressure deviation ΔP abnormality decision subroutine for front-left, front-right, rear-left, and rear-right wheel-brake fluid-pressure deviations ΔPFL, ΔPFR, ΔPRL, and ΔPRR.

At step S401, front-left wheel-brake fluid-pressure deviation ΔPFL is calculated as a deviation (Pt_FL−Pw_FL) between target front-left wheel cylinder pressure P*fl (=Pt_FL) and actual front-left wheel cylinder pressure Pfl (=Pw_FL), and then a comparative check is made to determine whether the calculated front-left wheel-brake fluid-pressure deviation ΔPFL exceeds predetermined threshold value k. When the answer to step S401 is affirmative (i.e., ΔPFL>k), the routine proceeds to step S402. Conversely when the answer to step S401 is negative (i.e., ΔPFL≦k), the routine proceeds to step S403.

At step S402, it is determined that an abnormality in front-left wheel-brake fluid-pressure deviation ΔPFL occurs. Thereafter, the routine proceeds to step S403.

At step S403, front-right wheel-brake fluid-pressure deviation ΔPFR is calculated as a deviation (Pt_FR−Pw_FR) between target front-right wheel cylinder pressure P*fr (=Pt_FR) and actual front-right wheel cylinder pressure Pfr (=Pw_FR), and then a comparative check is made to determine whether the calculated front-right wheel-brake fluid-pressure deviation ΔPFR exceeds predetermined threshold value k. When the answer to step S403 is affirmative (i.e., ΔPFR>k), the routine proceeds to step S404. Conversely when the answer to step S403 is negative (i.e., ΔPFR≦k), the routine proceeds to step S405.

At step S404, it is determined that an abnormality in front-right wheel-brake fluid-pressure deviation ΔPFR occurs. Thereafter, the routine proceeds to step S405.

At step S405, rear-left wheel-brake fluid-pressure deviation ΔPRL is calculated as a deviation (Pt_RL−Pw_RL) between target rear-left wheel cylinder pressure P*rl (=Pt_RL) and actual rear-left wheel cylinder pressure Prl (=Pw_RL), and then a comparative check is made to determine whether the calculated rear-left wheel-brake fluid-pressure deviation ΔPRL exceeds predetermined threshold value k. When the answer to step S405 is affirmative (i.e., ΔPRL>k), the routine proceeds to step S406. Conversely when the answer to step S405 is negative (i.e., ΔPRL>k), the routine proceeds to step S407.

At step S406, it is determined that an abnormality in rear-left wheel-brake fluid-pressure deviation ΔPRL occurs. Thereafter, the routine proceeds to step S407.

At step S407, rear-right wheel-brake fluid-pressure deviation ΔPRR is calculated as a deviation (Pt_RR−Pw_RR) between target rear-right wheel cylinder pressure P*rr (=Pt_RR) and actual rear-right wheel cylinder pressure Prr (=Pw_RR), and then a comparative check is made to determine whether the calculated rear-right wheel-brake fluid-pressure deviation ΔPRR exceeds predetermined threshold value k.

When the answer to step S407 is affirmative (i.e., ΔPRR>k), the routine proceeds to step S408. Conversely when the answer to step S407 is negative (i.e., ΔPRR≦k), one cycle of the fluid-pressure deviation ΔP abnormality decision subroutine terminates.

At step S408, it is determined that an abnormality in rear-right wheel-brake fluid-pressure deviation ΔPRR occurs. In this manner, one cycle of the fluid-pressure deviation ΔP abnormality decision subroutine terminates.

(Inflow-Quantity Estimate Arithmetic Calculation Flow in Second Embodiment)

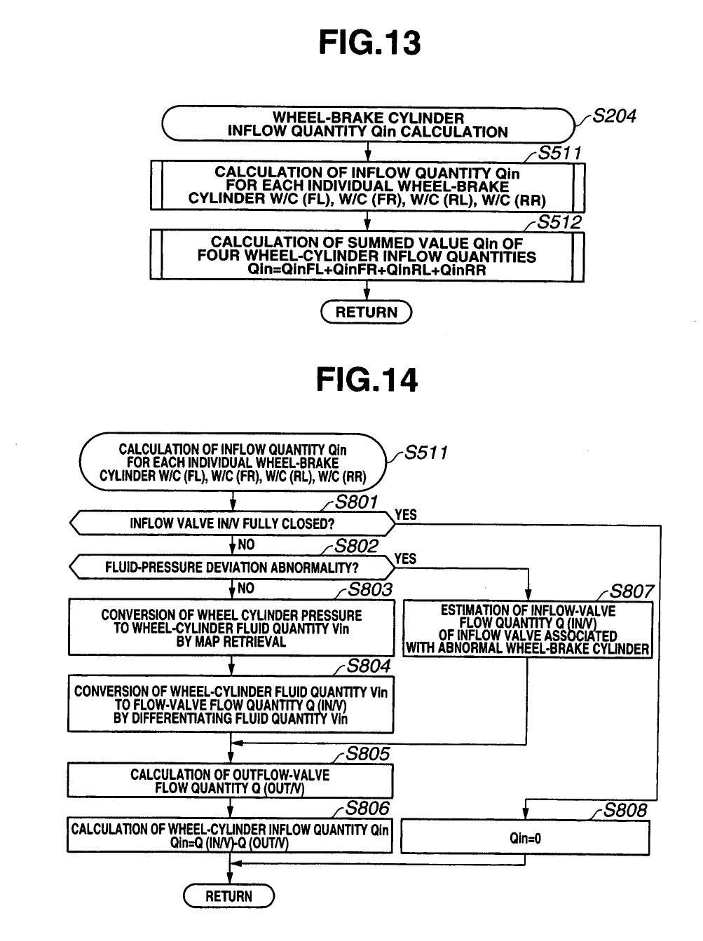

Referring to FIG. 13, there is shown the arithmetic routine for the estimate of inflow quantity Qin.

At step S511, front-left, front-right, rear-left, and rear-right wheel-cylinder inflow quantities QinFL, QinFR, QinRL, and QinRR are calculated. Thereafter, the subroutine proceeds to step S512.

At step S512, the summed value Qin of front-left, front-right, rear-left, and rear-right wheel-cylinder inflow quantities QinFL, QinFR, QinRL, and QinRR is calculated by the expression Qin=QinFL+QinFR+QinRL+QinRR. In this manner, one cycle of the inflow quantity Qin arithmetic processing of FIG. 13 terminates.

(Each Individual Wheel-Cylinder Inflow Quantity Arithmetic Calculation Flow in Second Embodiment)

Referring now to FIG. 14, there is shown the inflow quantity arithmetic routine for calculation of front-left, front-right, rear-left, and rear-right wheel-cylinder inflow quantities QinFL, QinFR, QinRL, and QinRR.

At step S801, a check is made to determine, based on a drive signal outputted to inflow valve IN/V(FL, FR, RL, RR), whether inflow valve IN/V is fully closed. When the answer to step S801 is affirmative (YES), that is, when the fully-closed state of inflow valve IN/V is detected, the routine proceeds to step S808. Conversely when the answer to step S801 is negative (NO), that is, when the fully-closed state of inflow valve IN/V is not detected, the routine proceeds to step S802.

At step S802, a check is made to determine whether the wheel-brake cylinder, associated with the inflow valve IN/V kept open, corresponds to the abnormal wheel-brake cylinder at which the fluid-pressure deviation ΔP abnormality is occurring due to a fluid-pressure sensor abnormality. When the answer to step S802 is affirmative (i.e., abnormal wheel-brake cylinder), it is determined that the fluid-pressure deviation ΔP abnormality is occurring at the wheel-brake cylinder associated with the inflow valve IN/V kept open, due to a fluid-pressure sensor abnormality. Thus, the routine proceeds from step S802 to step S807. Conversely when the answer to step S802 is negative (i.e., normal wheel-brake cylinder), the routine proceeds to step S803.

At step S803, the wheel cylinder pressure (Pw_FL, Pw_FR, Pw_RL, Pw_RR,) of each individual wheel-brake cylinder W/C(FL)-W/C(RR) is converted into a wheel-cylinder fluid quantity Vin from a preprogrammed pressure-to-fluid-quantity conversion map. Thereafter, step S804 occurs.

At step S804, an inflow-valve flow quantity Q(IN/V) is calculated by differentiating the wheel-cylinder fluid quantity Vin, obtained by the above-mentioned pressure-to-fluid-quantity conversion. Thereafter, step S805 occurs.

At step S805, an outflow-valve flow quantity Q(OUT/V) is calculated based on a drive signal outputted to outflow valve OUT/V(FL, FR, RL, RR) and the wheel cylinder pressure (Pw_FL, Pw_FR, Pw_RL, Pw_RR). Thereafter, step S806 occurs.

At step S806, wheel-cylinder inflow quantity Qin is calculated based on the calculated inflow-valve flow quantity Q(IN/V) and the calculated outflow-valve flow quantity Q(OUT/V), from the following expression.

Qin=Q(IN/V)−Q(OUT/V)

At step S807, the wheel cylinder pressure in the abnormal wheel-brake cylinder, whose fluid-pressure deviation ΔP abnormality is occurring due to a fluid-pressure sensor abnormality, is estimated by means of the emergency fluid-pressure sensor, which is operating normally and provided or screwed into pressure buildup circuit C. Then, inflow-valve flow quantity Q(IN/V) is calculated by differentiating the wheel-cylinder fluid quantity Vin converted from the estimated wheel-cylinder pressure of the abnormal wheel-brake cylinder. Thereafter, the routine proceeds to step S805.

At step S808, wheel-cylinder inflow quantity Qin is set to “0”, that is, Qin=0. In this manner, one cycle of each individual wheel-cylinder inflow quantity arithmetic processing of FIG. 14 terminates.

Additionally, in the brake control apparatus of the second embodiment, the orifice-constriction flow passage area “A” of the orifice portion of each of inflow valves IN/V(FL, FR, RL, RR) is set or adjusted to satisfy the previously-described mathematical expressions, that is,

Pv=(Q²·ρ)/(2·A²·C²) and Pv(max)≧(Pv1,Pv2).

[Effects of Second Embodiment]

(1-8) In the second embodiment shown in FIGS. 9-14, a single hydraulic unit HU, common to front-left, front-right, rear-left, and rear-right hydraulic wheel brakes, is provided for four-wheel brake-by-wire control for front and rear road wheels FL-RR of a four-wheeled vehicle. A single fluid pressure source (i.e., either main pump Main/P or sub-pump Sub/P) is installed in hydraulic unit HU, and four wheel-brake cylinders W/C are provided for respective front and rear road wheels FL-RR.

As set forth above, it is possible to provide almost the same effects (1), (1-4), (1-5), (1-6), and (2-7) as the first embodiment, in a four-wheeled vehicle in which four road wheels FL-RR are all subjected to BBW control via the single hydraulic unit HU.

### Third Embodiment

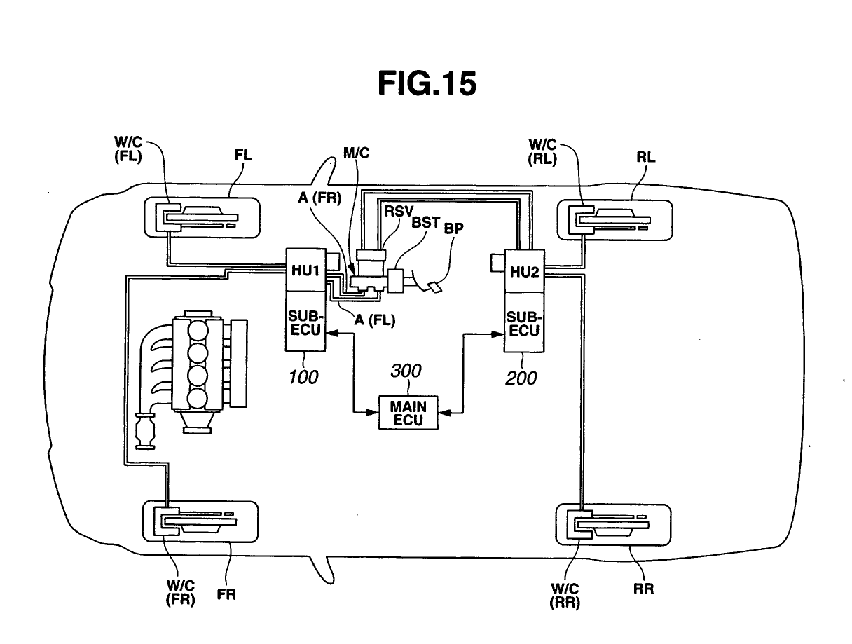

Referring now to FIGS. 15-17, there is shown the brake control apparatus of the third embodiment. The previously-described second embodiment is exemplified in a four-wheel brake-by-wire system equipped brake device in which wheel cylinder pressures of four road wheel-brake cylinders W/C(FL)-W/C(RR) are all built up by means of a single pump, that is, either main pump Main/P such as a gear pump built in hydraulic unit HU (see FIG. 10) or sub-pump Sub/P. On the other hand, the third embodiment is exemplified in a rear-wheel brake-by-wire system equipped brake device in which fluid pressure control of front wheel-brake cylinders W/C(FL)-W/C(FR) and fluid pressure control of rear wheel-brake cylinders W/C(RL)-W/C(RR) are performed independently of each other by means of respective pumps P1 and P2. In the third embodiment, the first pump P1 is driven by a first motor M1 and comprised of a tandem plunger pump installed in a first hydraulic unit HU1, whereas the second pump P2 is driven by a second motor M2 and comprised of a tandem plunger pump installed in a second hydraulic unit HU2.

In the previously-described first embodiment, during normal braking at a pressure buildup mode via the front-wheel BBW system, front-left and front-right wheel cylinder pressures Pfl-Pfr are built up by means of the single pump P. On the other hand, in the third embodiment, if necessary, a wheel-cylinder pressure buildup for each individual front wheel-brake cylinder W/C(FL)-W/C(FR) can be achieved by means of the first pump P1. During normal braking action by the driver, a front wheel-cylinder pressure buildup is achieved by master-cylinder pressure Pm amplified or multiplied by a brake booster BST. Brake-by-wire control is made to only the rear wheel-brake cylinders W/C(RL)-W/C(RR).

[Brake System Configuration]

FIG. 15 shows the brake control system configuration of the brake control apparatus of the third embodiment. First hydraulic unit HU1 is driven by means of first sub-ECU 100, whereas second hydraulic unit HU2 is driven by means of second sub-ECU 200. The first port of master cylinder M/C is connected to front-left wheel-brake cylinder W/C(FL), whereas the second port of master cylinder M/C is connected to front-right wheel-brake cylinder W/C(FR). Fluid pressure control of each of front-left and front-right wheel-brake cylinders W/C(FL) and W/C(FR) is performed by driving or operating first hydraulic unit HU1 by means of the first sub-ECU 100. On the other hand, rear wheel-brake cylinders W/C(RL)-W/C(RR) are not connected to master cylinder M/C, and thus fluid pressure control of each of rear wheel-brake cylinders W/C(RL)-W/C(RR) is performed by driving or operating second hydraulic unit HU2 via the second sub-ECU 200 by way of rear-wheel brake-by-wire control.

[Hydraulic Circuit in First Hydraulic Unit]

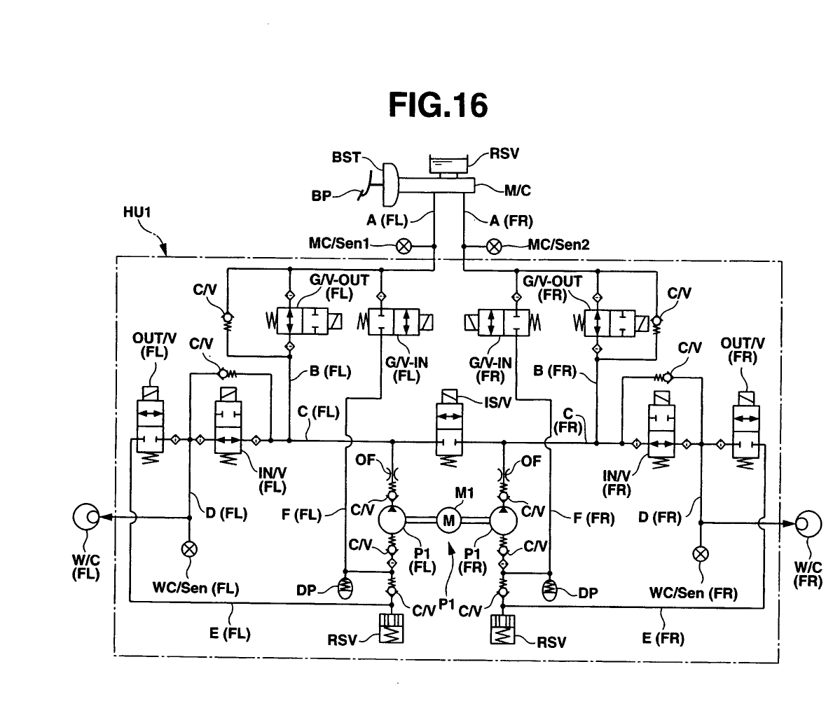

Referring to FIG. 16, there is shown a hydraulic circuit diagram of first hydraulic unit HU1 employed in the brake control apparatus of the third embodiment. The driver's brake-pedal depressing force is amplified by means of brake booster BST, and thus master-cylinder pressure Pm is multiplied or built up. Operations of electromagnetic valves G/V-IN, G/V-OUT, IN/V, OUT/V and IS/V, and first pump motor M1 are controlled via first sub-ECU 100 responsively to respective command signals from main ECU 300.

Each of first sub-ECU 100 and main ECU 300 receives information about master-cylinder pressures Pm1-Pm2 from first and second master-cylinder pressure sensors MC/Sen1-MC/Sen2, and wheel cylinder pressures Pfl-Pfr from two front wheel-cylinder pressure sensors WC/Sen(FL)-WC/Sen(FR).

Master cylinder M/C is a tandem master cylinder with two pistons set in tandem. The first port of master cylinder M/C is connected via fluid lines A(FL), B(FL), C(FL) and D(FL) to front-left wheel-brake cylinder W/C(FL), whereas the second port of master cylinder M/C is connected via fluid lines A(FR), B(FR), C(FR) and D(FR) to front-right wheel-brake cylinder W/C(FR).

Outflow gate valve G/V(FL, FR) is fluidly disposed in fluid line B(FL, FR), whereas inflow valve IN/V(FL, FR) is fluidly disposed in fluid line D(FL, FR). Each of front-left and front-right outflow gate valves G/V(FL)-G/V(FR) and front-left and front-right inflow valves IN/V(FL)-IN/V(FR) is comprised of a normally-open electromagnetic valve. In a hydraulic brake system failure, these valves G/V(FL)-G/V(FR) and IN/V(FL)-IN/V(FR) are forced (spring-biased) to their valve-open positions to permit fluid communication between master cylinder M/C and each individual front wheel-brake cylinder W/C(FL)-W/C(FR).

Fluid line D(FL, FR) is connected via a fluid line E(FL, FR) to reservoir RSV and the suction side of first pump P1. Outflow valve OUT/V(FL, FR), which is comprised of a normally-closed electromagnetic valve, is fluidly disposed in fluid line E(FL, FR). With outflow valves OUT/V(FL)-OUT/V(FR) kept open, front-left and front-right wheel cylinder pressures Pfl-Pfr are relieved into reservoir RSV and the suction side of first pump P1.

Fluid line A(FL, FR) is connected via a fluid line F(FL, FR) to the suction side of first pump P1. Inflow gate valve G/V-IN(FL, FR), which is comprised of a normally-closed electromagnetic valve, is fluidly disposed in fluid line F(FL, FR). With inflow gate valves G/V-IN(FL)-G/V-IN(FR) kept open, working fluid in master cylinder M/C is supplied to the suction side of first pump P1. A primary-circuit diaphragm pressure accumulator, simply a first diaphragm DP, is connected to fluid line F(FL) and disposed between front-left inflow gate valve G/V-IN(FL) and the suction port of the front-left plunger pump section P1(FL) of first pump P1, whereas a secondary-circuit diaphragm pressure accumulator, simply a second diaphragm DP, is connected to fluid line F(FR) and disposed between front-right inflow gate valve G/V-IN(FR) and the suction port of the front-right plunger pump section P1(FR) of first pump P1. These diaphragms DP assure a stable suction stroke of the first tandem plunger pump P1.

The discharge side (the first and second pump outlets) of first tandem plunger pump P1 is connected to fluid line C(FL, FR) to build up the fluid pressure in fluid line C(FL, FR). Backflow-prevention check valves C/V are fluidly disposed in respective fluid lines, namely, the discharge line and the suction line of front-left plunger pump section P1(FL) and the discharge line and the suction line of front-right plunger pump section P1(FR) to prevent working fluid from flowing back to the discharge ports of first pump P1 and permit working fluid flow into the suction ports of first pump P1. Additionally, an orifice OF is fluidly disposed in each of the discharge lines of front-left and front-right plunger pump sections P1(FL)-P1(FR) to reduce pulse pressures.

Front-left and front-right fluid lines C(FL)-C(FR), which lines communicate with the respective discharge lines of front-left and front-right plunger pump sections P1(FL)-P1 (FR), are connected to each other via a normally-closed isolation valve IS/V. With isolation valve IS/V fully closed, it is possible to realize independent fluid pressure supply between front-left and front-right wheel-brake cylinders, that is, (1) the first fluid-pressure supply system from the first outlet port of first pump P1 to front-left wheel-brake cylinder W/C(FL) and (2) the second fluid-pressure supply system from the second outlet port of first pump P1 to front-right wheel-brake cylinder W/C(FR) separately from each other. By the use of the two separate fluid-pressure supply systems, if one of front-left and front-right wheel-brake systems fails, the other unfailed wheel-brake system can still provide braking.

Two check valves C/V are provided in parallel with respective outflow gate valves G/V-OUT(FL, FR), and additionally two check valves C/v are provided in parallel with respective inflow valves IN/V(FL, FR), to prevent backflow of working fluid from front wheel-brake cylinders W/C(FL, FR) back to master cylinder M/C.

[Front Wheel Cylinder Pressure Control]

(During Pressure Buildup, Utilizing Master-Cylinder Pressure Pm)

During a normal pressure buildup mode, utilizing master-cylinder pressure Pm, front-left and front-right outflow gate valves G/V-OUT(FL, FR) and front-left and front-right inflow valves IN/V(FL, FR) are kept open (de-energized), and the other valves are all kept closed, to supply master-cylinder pressure Pm multiplied or built up by brake booster BST to front wheel-brake cylinders W/C(FL, FR).

(During Pressure Buildup, Utilizing Pump P1)

During a pressure buildup mode, utilizing first pump P1, front-left and front-right inflow gate valves G/V-IN(FL, FR) and front-left and front-right inflow valves IN/V(FL, FR) are kept open, the other valves are all kept closed, and first motor M1 is driven. First pump P1(FL, FR) is driven in such a manner as to induct working fluid in master cylinder M/C via fluid line F(FL, FR) into the pump inlet ports of front-left and front-right plunger pump sections P1(FL)-P1(FR). The pump discharge pressure is introduced via fluid lines C(FL, FR) and D(FL, FR) to each individual front wheel-brake cylinder W/C(FL, FR).

(During Pressure Hold)

During a pressure hold mode, inflow valves IN/V(FL, FR) and outflow valves OUT/V(FL, FR) are all kept closed, to keep wheel cylinder pressures Pfl-Pfr unchanged.

(During Pressure Reduction)

During a pressure reduction mode, outflow valves OUT/V(FL, FR) are kept open, for exhausting working fluid in front wheel-brake cylinders W/C(FL, FR) via fluid line E(FL, FR) into reservoir RSV. Working fluid in reservoir RSV is discharged into fluid line B(FL, FR) by means of first pump P1(FL, FR), and then returned via outflow gate valves G/V-OUT(FL, FR), which are kept open, back to master cylinder M/C.

[Hydraulic Circuit in Second Hydraulic Unit]

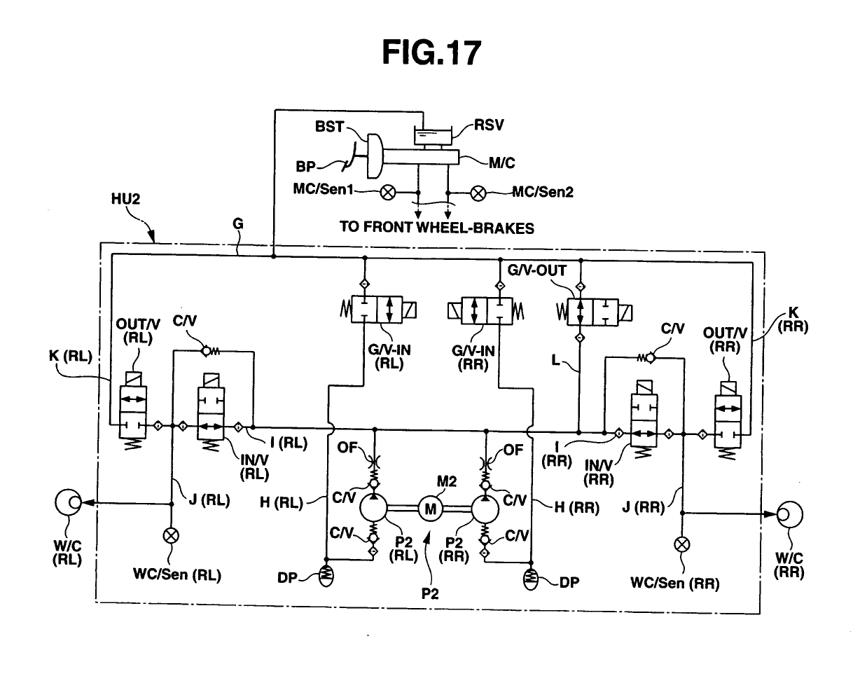

Referring to FIG. 17, there is shown a hydraulic circuit diagram of second hydraulic unit HU2 employed in the brake control apparatus of the third embodiment. Second hydraulic unit HU2 is not connected to master cylinder M/C. Braking forces applied to rear road wheels RL-RR are produced by operating second pump P2(RL, RR) built in second hydraulic unit HU2 by way of rear-wheel brake-by-wire control.

In a similar manner to first hydraulic unit HU1, operations of electromagnetic valves G/V-IN, G/V-OUT, IN/V and OUT/V, and second pump motor M2, incorporated in second hydraulic unit HU2, are controlled via second sub-ECU 200 responsively to respective command signals from main ECU 300. Backflow-prevention check valves C/V are fluidly disposed in respective fluid lines, namely, the discharge line and the suction line of rear-left plunger pump section P2(RL) and the discharge line and the suction line of rear-right plunger pump section P2(RR) to prevent working fluid from flowing back to the discharge ports of second pump P2 and permit working fluid flow into the suction ports of second pump P2. Additionally, orifice OF is fluidly disposed in each of the discharge lines of rear-left and rear-right plunger pump sections P2(RL)-P2(RR) to reduce pulse pressures.

Master-cylinder reservoir RSV is connected to a fluid line G. Fluid line G is connected via respective fluid lines H(RL, RR) to the suction ports of rear-left and rear-right plunger pump sections P2(RL)-P2(RR) of second pump P2. Inflow gate valves G/V-IN(RL, RR), each of which is comprised of a normally-closed electromagnetic valve, are fluidly disposed in respective fluid lines H(RL, RR). With inflow gate valves G/V-IN(RL, RR) kept open (energized), fluid communication between master-cylinder reservoir RSV and the suction ports of rear-left and rear-right plunger pump sections P2(RL)-P2(RR) is established. First diaphragm DP is connected to fluid line H(RL) and disposed between rear-left inflow gate valve G/V-IN(RL) and the suction port of the rear-left plunger pump section P2(RL) of second pump P2, whereas second diaphragm DP is connected to fluid line H(RR) and disposed between rear-right inflow gate valve G/V-IN(RR) and the suction port of the rear-right plunger pump section P2(RR) of second pump P2. These diaphragms DP assure a stable suction stroke of the second tandem plunger pump P2.

The discharge side (the first and second pump outlets) of second tandem plunger pump P2 is connected to a fluid line I(RL, RR). Fluid lines I(RL, RR) are connected via fluid lines J(RL, RR) to respective rear wheel-brake cylinders W/C(RL, RR). Normally-open inflow valves IN/V(RL, RR) are fluidly disposed in respective fluid lines I(RL, RR). With inflow valves IN/V(RL, RR) kept open (de-energized), fluid communication between the discharge side of second pump P2 and each individual rear wheel-brake cylinder W/C(RL, RR) is established. Two check valves C/V are provided in parallel with respective inflow valves IN/V(RL, RR) to prevent backflow of working fluid from rear wheel-brake cylinders W/C(RL, RR) back to master-cylinder reservoir RSV.

Fluid line I(RL, RR) and fluid line J(RL, RR) are connected via a fluid line K(RL, RR) to fluid line G. Normally-closed outflow valves OUT/V(RL, RR) are fluidly disposed in respective fluid lines K(RL, RR). With outflow valves OUT/V(RL, RR) kept open (energized), fluid communication between fluid line G and each individual rear wheel-brake cylinder W/C(RL, RR) is established.

[Rear Wheel Cylinder Pressure Control]

(During Pressure Buildup, Utilizing Pump P2)

There is no introduction of master-cylinder pressure Pm into second hydraulic unit HU2, and thus a pressure buildup is achieved by second pump P2 by way of rear-wheel brake-by-wire control. During a pressure buildup mode, inflow gate valves G/V-IN(RL, RR) and inflow valves IN/V(RL, RR) are kept open, the other valves are kept closed, and second motor M2 is driven. Second pump P2(RL, RR) is driven in such a manner as to induct working fluid in master-cylinder reservoir RSV via fluid line G and fluid lines H(RL, RR) into the pump inlet ports of rear-left and rear-right plunger pump sections P2(RL)-P2(RR). The pump discharge pressure is introduced via fluid lines I(RL, RR) and J(RL, RR) to each individual rear wheel-brake cylinder W/C(RL, RR).

(During Pressure Hold)

During a pressure hold mode, inflow valves IN/V(RL, RR) and outflow valves OUT/V(RL, RR) are all kept closed, to keep wheel cylinder pressures Prl-Prr unchanged.

(During Pressure Reduction)

During a pressure reduction mode, outflow valves OUT/V(RL, RR) are kept open, for exhausting working fluid in rear wheel-brake cylinders W/C(RL, RR) via fluid lines K(RL, RR) and G into master-cylinder reservoir RSV.

[Abnormality Detection Control in Third Embodiment]

In the third embodiment, front wheel cylinder pressures Pfl-Pfr are built up by a single pump (first pump P1 built in first hydraulic unit HU1), whereas rear wheel cylinder pressures Prl-Prr are built up by a single pump (second pump P2 built in second hydraulic unit HU2).

Additionally, in the brake control apparatus of the third embodiment, the orifice-constriction flow passage area “A” of the orifice portion of each of inflow valves IN/V(FL, FR, RL, RR) is set or adjusted to satisfy the previously-described mathematical expressions, that is,

Pv=(Q²·ρ)/(2·A²·C²) and Pv(max)≧(Pv1,Pv2).

Thus, by executing the same abnormality detection control as the first embodiment for the rear wheel-brake system of rear road wheels RL-RR as well as the front wheel-brake system of front road wheels FL-FR, the brake control apparatus of the third embodiment can provide the following effects.

[Effects of Third Embodiment]

(1-9) In the third embodiment shown in FIGS. 15-17, hydraulic actuators (hydraulic modulators) are constructed by first hydraulic unit HU1 for the front wheel-brake system and second hydraulic unit HU2 for the rear wheel-brake system. The fluid pressure source is comprised of first pump P1 (1st tandem plunger pump having front-left and front-right plunger pump sections P1(FL)-P1(FR), and second pump P2 (2nd tandem plunger pump having rear-left and rear-right plunger pump sections P2(RL)-P2(RR). Four wheel-brake cylinders W/C(FL-RR) are mounted on respective road wheels FL, FR, RL, and RR. Front wheel-brake cylinders W/C(FL, FR) are connected to first hydraulic unit HU1, whereas rear wheel-brake cylinders W/C(RL, RR) are connected to second hydraulic unit HU2.

As set forth above, it is possible to provide almost the same effects (1), (1-1), (1-4), (1-5), (1-6), and (2-7) as the first embodiment, in a dual-hydraulic-unit, two-wheel BBW control system equipped four-wheeled vehicle in which fluid-pressure control of front-left and front-right hydraulic wheel brakes is performed by first hydraulic unit HU1, fluid-pressure control of rear-left and rear-right hydraulic wheel brakes is performed by second hydraulic unit HU2, and additionally rear road wheels RL-RR are subjected to BBW control via the second hydraulic unit HU2.

### Fourth Embodiment

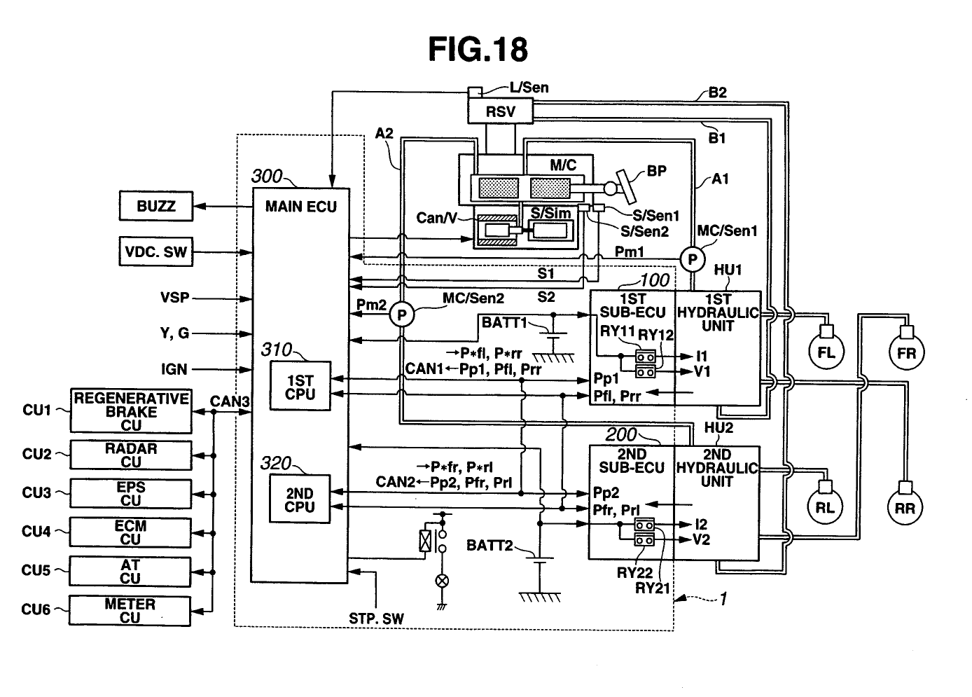

Referring now to FIGS. 18-20, there is shown the brake control apparatus of the fourth embodiment. In the previously-discussed rear-wheel BBW system equipped brake control apparatus of the third embodiment, fluid-pressure control of the front-wheel side wheel brakes (i.e., front-left and front-right wheel cylinder pressures Pfl and Pfr) and fluid-pressure control of the rear-wheel side wheel brakes (i.e., rear-left and rear-right wheel cylinder pressures Prl and Prr) are controlled independently of each other by means of respective hydraulic units, namely, first and second hydraulic units HU1-HU2. On the other hand, the four-wheel BBW system equipped brake control apparatus of the fourth embodiment is applied to an automotive vehicle employing a so-called diagonal split layout of brake circuits, sometimes termed “X-split layout”, in which one part of the tandem master cylinder output is connected via the first hydraulic unit HU1 to front-left and rear-right wheel-brake cylinders W/C(FL) and W/C(RR) and the other part is connected via the second hydraulic unit HU2 to front-right and rear-left wheel-brake cylinders W/C(FR) and W/C(RL). Thus, in the fourth embodiment, fluid pressures in front-left and rear-right wheel-brake cylinders W/C(FL) and W/C(RR) are regulated or controlled via the first hydraulic unit HU1, while fluid pressures in front-right and rear-left wheel-brake cylinders W/C(FR) and W/C(RL) are regulated or controlled via the second hydraulic unit HU2. In the fourth embodiment, during normal braking at a pressure buildup mode via the four-wheel BBW system, fluid pressures Pfl and Prr in front-left and rear-right wheel-brake cylinders W/C(FL) and W/C(RR) included in the first wheel-brake system is built up by first pump P1 installed in first hydraulic unit HU1, and fluid pressures Pfr and Prl in front-right and rear-left wheel-brake cylinders W/C(FR) and W/C(RL) included in the second wheel-brake system are built up by second pump P2 installed in second hydraulic unit HU2. Only when a brake-by-wire system failure occurs, the operating mode of the four-wheel BBW system equipped brake control apparatus of the fourth embodiment has been switched to a manual brake mode, at which master-cylinder pressure Pm can be introduced into front-left and front-right wheel-brake cylinders W/C(FL) and W/C(FR).

[Brake System Configuration]

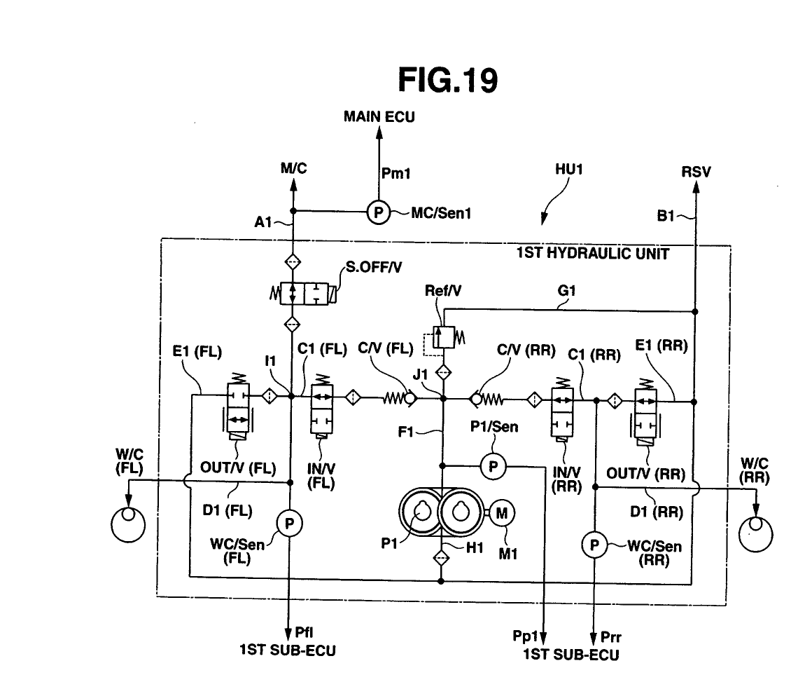

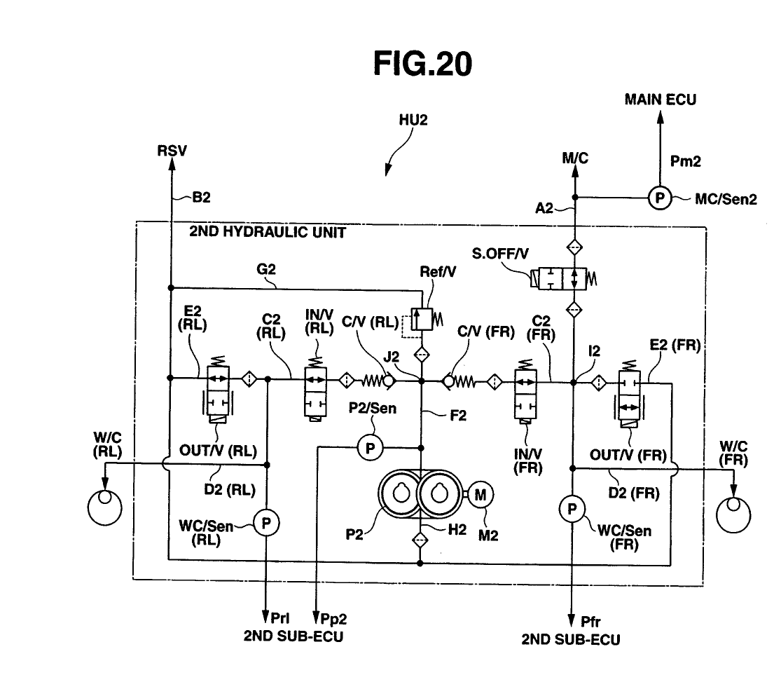

FIG. 18 shows the brake control system configuration of the brake control apparatus of the fourth embodiment. First and second hydraulic units HU1-HU2 are driven by means of respective sub-electronic control units (sub-ECUs) 100 and 200 responsively to a command signal from main electronic control unit (main ECU) 300. A reaction force applied to brake pedal BP is created by means of stroke simulator S/Sim connected to master cylinder M/C. First hydraulic unit HU1 is connected via a fluid line A1 to a first port of master cylinder M/C, whereas second hydraulic unit HU2 is connected via a fluid line A2 to a second port of master cylinder M/C. Master cylinder M/C is a tandem master cylinder with two pistons set in tandem. Also, first hydraulic unit HU1 is connected via a fluid line B1 to brake-fluid reservoir (master-cylinder reservoir) RSV, whereas second hydraulic unit HU2 is connected via a fluid line B2 to master-cylinder reservoir RSV. First master-cylinder pressure sensor MC/Sen1 is provided or screwed into the fluid line A1, whereas second master-cylinder pressure sensor MC/Sen2 is provided or screwed into the fluid line A2. First hydraulic unit HU1 is comprised of first pump P1, first motor M1, and electromagnetic valves (see FIG. 19). In a similar manner, second hydraulic unit HU2 is comprised of second pump P2, second motor M2, and electromagnetic valves (see FIG. 20). First and second hydraulic units HU1-HU2 are configured as hydraulic actuators (hydraulic modulators) capable of generating fluid pressures independently of each other. First hydraulic unit HU1 is used for fluid-pressure control of wheel-cylinder pressures of front-left road wheel FL and rear-right road wheel RR. Second hydraulic unit HU2 is used for fluid-pressure control of wheel-cylinder pressures of front-right road wheel FR and rear-left road wheel RL. That is, wheel-cylinder pressures of wheel-brake cylinders W/C(FL)-W/C(RR) can be directly built up by means of pumps P1-P2, serving as two different fluid-pressure sources, each producing a fluid pressure independently of master cylinder M/C (a pressure source during a manual brake mode). It is possible to build up the wheel-cylinder pressures directly by these pumps P1-P2 without using any pressure accumulators, and thus there is no risk of undesirable blending (leakage) of gas in the accumulator into working fluid in the fluid lines in the presence of a brake system failure. As discussed above, first pump P1 functions to build up wheel-cylinder pressures of a first pair of diagonally-opposed road wheels, namely, front-left and rear-right road wheels FL and RR, whereas second pump P2 functions to build up wheel-cylinder pressures of a second pair of diagonally-opposed road wheels, namely, front-right and rear-left road wheels FR and RL. That is, first and second pumps P1-P2 are provided to construct a so-called diagonal split layout of brake circuits, sometimes termed “X-split layout”. First hydraulic unit HU1 and second hydraulic unit HU2 are configured to be separated from each other. By the use of the two separate hydraulic units HU1-HU2, even if there is a leakage of working fluid from either one of first and second hydraulic units HU1-HU2, it is possible to certainly produce a braking force by the other unfailed hydraulic unit. As set forth above, first and second hydraulic units HU1-HU2 are configured as separate units, but it is preferable that these hydraulic units HU1-HU2 are integrally connected to each other. This is because electric circuit configurations can be gathered to one place. This contributes to shortened harness lengths and simplified brake system layout.

From the viewpoint of the more compact brake system configuration, on the one hand, it is desirable to reduce the number of fluid-pressure sources. On the other hand, in case of the use of a single brake-fluid pressure source (only one fluid-pressure pump), there will not be any backup fluid-pressure source. In contrast, assuming that four fluid-pressure sources are provided at respective road wheels FL, FR, RR, and RL, this is advantageous with respect to enhanced fail-safe performance but leads to the problem of a large-sized brake system and more complicated brake system control. Generally, it is necessary to further incorporate a redundant system in case of brake-by-wire control. There is a risk of divergence of the system owing to the increased fluid-pressure sources.

Recently, as a general layout of brake circuits, a so-called diagonal split layout of brake circuits, sometimes termed “X-split layout” is used. In the usual “X-split layout”, one of two different fluid-pressure sources (e.g., one part of the tandem master cylinder output) is connected via a first brake circuit to front-left and rear-right wheel-brake cylinders W/C(FL) and W/C(RR) and the other fluid-pressure source (e.g., the other part of the tandem master cylinder output) is connected via a second brake circuit to front-right and rear-left wheel-brake cylinders W/C(FR) and W/C(RL), so as to be able to independently build up the first and second brake systems by means of the respective fluid-pressure sources (e.g., the two port outputs of the tandem master cylinder). By virtue of the use of the X-split layout, for instance, assuming that the brake circuit associated with front-left wheel-brake cylinder W/C(FL) is failed, the brake circuit associated with rear-right wheel-brake cylinder W/C(RR) becomes failed simultaneously, and thus the system permits simultaneous braking force application to both of the front-right and rear-left road wheels by the unfailed brake circuit (the second brake circuit). Conversely assuming that the brake circuit associated with front-right wheel-brake cylinder W/C(FR) is failed, the brake circuit associated with rear-left wheel-brake cylinder W/C(RL) becomes failed simultaneously, and thus the system permits simultaneous braking force application to both of the front-left and rear-right road wheels by the unfailed brake circuit (the first brake circuit). Therefore, such an X-split layout is superior in braking-force balance of the vehicle even when either one of the first brake circuit (the first fluid-pressure source P1) associated with front-left and rear-right wheel-brake cylinders W/C(FL) and W/C(RR) and the second brake circuit (the second fluid-pressure source P2) associated with front-right and rear-left wheel-brake cylinders W/C(FR) and W/C(RL) is failed. The use of X-split layout contributes to the enhanced braking-force balance of the vehicle. As a prerequisite for the X-split layout, the number of fluid-pressure sources must be two.

For the reasons discussed above, in case of the use of only one fluid-pressure source, it is impossible to provide an “X-split layout”. In case of the use of three fluid-pressure sources respectively associated with front-left wheel FL, front-right wheel FR, and rear wheels RL-RR or in case of the use of four fluid-pressure sources associated with respective road wheels FL, FR, RL, and RR, it is impossible to connect diagonally-opposed road wheels with the same fluid-pressure source.

Therefore, the brake apparatus of the present embodiment is configured or designed to construct a dual fluid-pressure source system by way of first and second hydraulic units HU1-HU2 having respective pumps P1-P2 serving as two separate fluid-pressure sources, in order to enhance a fail-safe performance without changing the widespread or widely-used “X-split layout”.

As is generally known, owing to a wheel load shift during braking, a front wheel load tends to become greater than a rear wheel load, and thus a rear-wheel braking force is not so great. Additionally, there is a possibility of a rear wheel spin in case of an excessive rear-wheel braking force. For the reasons discussed above, for a general braking force distribution between front and rear road wheels, a front-wheel braking force is designed to be greater than a rear-wheel braking force. For instance, the ratio of front-wheel braking force to rear-wheel braking force is 2:1.

Suppose that a multiple fluid-pressure source system is utilized to enhance the fail-safe performance and thus a plurality of hydraulic units are mounted on the vehicle. In such a case, from the viewpoint of reduced costs, it is desirable to mount the hydraulic units having the same specification on the vehicle. However, assuming that fluid-pressure sources are provided for all of four road wheels, from the viewpoint of a braking force distribution between front and rear wheels, two sorts of hydraulic units, having respective specifications differing from each other, must be prepared for front and rear wheels. This means increased manufacturing costs. In case of the system having three fluid-pressure sources, the same problem (the increased costs) occurs, because of a front-and-rear wheel braking force distribution, that is, setting of a greater front-wheel braking force and a smaller rear-wheel braking force.

For the reasons discussed above, in the brake control apparatus of the fourth embodiment, two hydraulic units HU1-HU2, having the same specification, are utilized and configured to provide an “X-split layout”. Note that, in the hydraulic circuits of hydraulic units HU1-HU2, the valve openings are preset such that the ratio of a fluid pressure for front wheels FL, FR to a fluid pressure for rear wheels RL, RR is 2:1. In this manner, by installing two hydraulic units HU1-HU2, having the same specification, on the vehicle, it is possible to realize the front-and-rear wheel braking force distribution of 2:1, while achieving an inexpensive dual fluid-pressure source system.

[Main ECU]

Main ECU 300 is a broader central processing unit (CPU) that calculates a target front-left wheel-cylinder pressure P*fl and a target rear-right wheel-cylinder pressure P*rr for first hydraulic unit HU1 and also calculates a target front-right wheel-cylinder pressure P*fr and a target rear-left wheel-cylinder pressure P*rl for second hydraulic unit HU2. Main ECU 300 is connected to both of a first electric power source BATT1 and a second electric power source BATT2, in such a manner as to be able to operate, if at least one of power sources BATT1-BATT2 is operating normally. Main ECU 300 is started responsively to an ignition switch signal IGN from an ignition switch or responsively to an ECU starting requirement from each of control units CU1 to CU6, each of which is connected via a controller area network (CAN) communications line CAN3 to main ECU 300.

The input interface circuitry of main ECU 300 receives a stroke signal S1 from a first stroke sensor S/Sen1, a stroke signal S2 from a second stroke sensor S/Sen2, a master-cylinder pressure signal from first master-cylinder pressure sensor MC/Sen1 indicative of master-cylinder pressure Pm1, and a master-cylinder pressure signal from second master-cylinder pressure sensor MC/Sen2 indicative of master-cylinder pressure Pm2. As used hereafter, 1^{st} and 2^{nd} master-cylinder pressures Pm1-Pm2 are collectively referred to as “master-cylinder pressure Pm”. The input interface circuitry of main ECU 300 also receives a vehicle speed sensor signal indicative of vehicle speed VSP, a yaw rate sensor signal indicative of yaw rate Y, and a longitudinal-G sensor signal indicative of longitudinal acceleration G. Furthermore, the input interface circuitry of main ECU 300 receives a sensor signal from a brake-fluid quantity sensor L/Sen that detects a quantity of brake fluid in master-cylinder reservoir RSV. On the basis of the detected value of brake-fluid quantity sensor L/Sen, it is determined whether or not brake-by-wire (BBW) control is executable by driving pumps P1-P2. The input interface circuitry of main ECU 300 also receives a sensor signal from a stop lamp switch STP.SW, so as to detect a manipulation (a depression) of brake pedal BP by the driver, without using stroke signals S1-S2 and master-cylinder pressures Pm1-Pm2.

Two central processing units (CPUs), that is, first CPU 310 and second CPU 320, are provided in main ECU 300 for arithmetic calculations. First CPU 310 is connected to first sub-ECU 100 via a CAN communications line CAN1, whereas second CPU 320 is connected to second sub-ECU 200 via a CAN communications line CAN2. Signals, respectively indicating pump discharge pressure Pp1 discharged from first pump P1, and actual front-left and rear-right wheel cylinder pressures Pfl and Prr, are input via first sub-ECU 100 into first CPU 310. Signals, respectively indicating pump discharge pressure Pp2 discharged from second pump P2, and actual front-right and rear-left wheel-cylinder pressures Pfr and Prl, are input via second sub-ECU 200 into second CPU 320. These CAN communications lines CAN1-CAN2 are connected to each other for the purpose of a dual backup network communications system.

On the basis of the input information, such as stroke signals S1-S2, master-cylinder pressures Pm1-Pm2, and actual wheel-brake cylinder pressures Pfl, Pfr, Prl, and Prr, first CPU 310 calculates target front-left wheel cylinder pressure P*fl and target rear-right wheel cylinder pressure P*rr to generate the calculated target wheel cylinder pressures P*fl and P*rr via the first CAN communications line CAN1 to first sub-ECU 100, while second CPU 320 calculates target front-right wheel cylinder pressure P*fr and target rear-left wheel cylinder pressure P*rl to generate the calculated target wheel cylinder pressures P*fr and P*rl via the second CAN communications line CAN2 to second sub-ECU 200. In lieu thereof, the four target wheel-cylinder pressures P*fl to P*rr for first and second hydraulic units HU1-HU2 may be all calculated within first CPU 310, whereas second CPU 320 may be used as a backup CPU for first CPU 310.

Main ECU 300 functions to start up each of first and second sub-ECUs 100-200 via CAN communications lines CAN1-CAN2. In the shown embodiment, main ECU 300 generates two command signals for starting up respective sub-ECUs 100-200 independently of each other. In lieu thereof, sub-ECUs 100-200 may be started up simultaneously in response to a single command signal from main ECU 300. Alternatively, sub-ECUs 100-200 may be started up simultaneously in response to ignition switch signal IGN.

During execution of vehicle dynamic-behavior control including anti-skid brake control (often abbreviated to “ABS”, which is executed for increasing or decreasing a braking force for wheel-lock prevention), vehicle dynamics control (often abbreviated to “VDC”, which is executed for increasing or decreasing a braking force to prevent side slip occurring due to instable vehicle behaviors), traction control (often abbreviated to “TCS”, which is executed for acceleration-slip suppression of drive wheels), and the like, input information, such as vehicle speed VSP, yaw rate Y, and longitudinal acceleration G, is further extracted, for executing fluid-pressure control concerning target wheel cylinder pressures P*fl, P*fr, P*rl, and P*rr. During the vehicle dynamics control (VDC), a warning buzzer BUZZ emits a buzzing sound cyclically to warn the driver or vehicle occupants that the VDC system comes into operation. A VDC switch VDC.SW, serving as a man-machine interface, is also provided so as to manually engage or disengage the VDC function via the VDC switch VDC.SW in accordance with the driver's wishes.

Main ECU 300 is also connected to the other control units CU1 to CU6 via CAN communications line CAN3 for cooperative control. For energy regeneration, the regenerative brake control unit CU1 is provided to return a braking force to an electric supply system by way of conversion from kinetic energy into electric energy. The radar control unit CU2 is provided for vehicle-to-vehicle distance control. The EPS control unit CU3 serves as a control unit for an electrically-operated (motor-driven) power steering system.

The ECM control unit CU4 is an engine control unit, the AT control unit CU5 is an automatic transmission control unit, and the meter control unit CU6 is provided to control each of meters. The input information indicative of vehicle speed VSP, input into main ECU 300, is generated via CAN communications line CAN3 into each of ECM control unit CU4, AT control unit CU5, and meter control unit CU6.

First and second power sources BATT1-BATT2 correspond to electric power sources for ECUs 100, 200, and 300. Concretely, first power source BATT1 is connected to main ECU 300 and first sub-ECU 100, whereas second power source BATT2 is connected to main ECU 300 and second sub-ECU 200.

[Sub-ECUS]

In the shown embodiment, first sub-ECU 100 is formed integral with first hydraulic unit HU1, whereas second sub-ECU 200 is formed integral with second hydraulic unit HU2. Depending upon the type of vehicle or the required layout, first sub-ECU 100 and first hydraulic unit HU1 may be formed separately from each other, whereas second sub-ECU 200 and second hydraulic unit HU2 may be formed separately from each other.

In the shown embodiment, first sub-ECU 100 receives input informational signals, generated from main ECU 300 and indicating target wheel cylinder pressures P*fl and P*rr, and also receives input informational signals, generated from first hydraulic unit HU1 and indicating pump discharge pressure Pp1 discharged from first pump P1 and actual front-left and rear-right wheel cylinder pressures Pfl and Prr. In a similar manner, second sub-ECU 200 receives input informational signals, generated from main ECU 300 and indicating target wheel cylinder pressures P*fr and P*rl, and also receives input informational signals, generated from second hydraulic unit HU2 and indicating pump discharge pressure Pp2 discharged from second pump P2 and actual front-right and rear-left wheel cylinder pressures Pfr and Prl.

On the basis of the latest up-to-date informational data (more recent data) about pump discharge pressures Pp1-Pp2 and actual wheel cylinder pressures Pfl-Prr, the fluid-pressure control is performed to realize target wheel cylinder pressures P*fl-P*rr by driving the electromagnetic valves and motors M1-M2 for pumps P1-P2 incorporated in the respective hydraulic units HU1-HU2.

The previously-noted first sub-ECU 100 constructs a servo control system that continuously executes fluid-pressure control for front-left and rear-right wheels FL and RR, based on the previous values concerning target wheel cylinder pressure inputs P*fl and P*rr in such a manner as to bring or converge actual wheel cylinder pressures Pfl and Prr closer to these previous values, until new target values are inputted. In a similar manner, the previously-noted second sub-ECU 200 constructs a servo control system that continuously executes fluid-pressure control for front-right and rear-left wheels FR and RL, based on the previous values concerning target wheel cylinder pressure inputs P*fr and P*rl in such a manner as to bring or converge actual wheel cylinder pressures Pfr and Prl closer to these previous values, until new target values are inputted.

By means of first sub-ECU 100, electric power from first power source BATT1 is converted into a valve driving current I1 and a motor driving voltage V1 of first hydraulic unit HU1, and then the converted valve driving current I1 and motor driving voltage V1 are relayed through respective relays RY11-RY12 to first hydraulic unit HU1. In a similar manner, by means of second sub-ECU 200, electric power from second power source BATT2 is converted into a valve driving current I2 and a motor driving voltage V2 of second hydraulic unit HU2, and then the converted valve driving current I2 and motor driving voltage V2 are relayed through respective relays RY21-RY22 to second hydraulic unit HU2.

[Target Values Calculation for Hydraulic Units and Driving Current/Voltage Control, Separated from Each Other]

As previously discussed, main ECU 300 is configured to execute arithmetic processing for target values P*fl-P*rr for first and second hydraulic units HU1-HU2, but not configured to execute the previously-noted driving current/voltage control concerning valve driving currents I1-I2 and motor driving voltages V1-V2. Assuming that main ECU 300 is configured to execute the driving current/voltage control as well as the target wheel cylinder pressure calculations, main ECU 300 must generate driving command signals to first and second hydraulic units HU1-HU2 according to cooperative control with the other control units CU1-CU6 by way of controller area network (CAN) communications and the like. In such a case, target wheel cylinder pressures P*fl to P*rr are outputted after arithmetic operations of CAN communications line CAN3 and the other control units CU1-CU6 have terminated. On the assumption that a transmission speed of CAN communications line CAN3 and operation speeds of the other control units CU1-CU6 are slow, there is an undesirable response delay in fluid-pressure control (brake control). One way to avoid such an undesirable response delay is to increase the transmission speed of each of communications lines needed for connections with the other controllers installed inside of the vehicle. However, this leads to another problem of increased costs. Additionally, a deterioration in fail-safe performance occurs owing to noise caused by the increased transmission speed.

For the reasons discussed above, in the fourth embodiment, the role of main ECU 300 is limited to arithmetic operations of target wheel cylinder pressures P*fl to P*rr, and additionally driving control for first and second hydraulic units HU1-HU2 is performed by first and second sub-ECUs 100-200 each constructing the servo control system.

With the previously-noted arrangement, first and second sub-ECUs 100-200 specialize in driving control for first and second hydraulic units HU1-HU2, while cooperative control with the other control units CU1-CU6 is performed by main ECU 300. Thus, it is possible to execute fluid-pressure control (brake control) without being affected by several factors, i.e., the transmission speed of CAN communications line CAN3 and operation speeds of control units CU1-Cu6.

Therefore, even when an integrated controller for a regenerative cooperative brake system needed for a hybrid vehicle (HV) or a fuel-cell vehicle (FCV), an integrated vehicle control system, and/or an intelligent transport system (ITS) is further added, it is possible to ensure or realize a high brake control responsiveness while smoothly planning fusion with these additional units/systems, by independently controlling the brake control system separately from the other control systems.

The BBW system equipped brake control apparatus of the embodiment, requires very precise, fine fluid-pressure control suited to a manipulated variable (a depression stroke) of brake pedal BP, during normal braking operations, frequently performed. Thus, separating arithmetic operations of target wheel cylinder pressures P*fl to P*rr for hydraulic units HU1-HU2 from driving control for hydraulic units HU1-HU2 is very effective and advantageous.

[Master Cylinder and Stroke Simulator]

Stroke simulator S/Sim is built in master cylinder M/C and provided to generate a reaction force of brake pedal BP. Also provided in master cylinder M/C is a stroke-simulator cutoff valve Can/V for establishing or blocking fluid communication between master cylinder M/C and stroke simulator S/Sim.

Open and closed operation of stroke-simulator cutoff valve Can/V is controlled by means of main ECU 300, such that rapid switching to a manual brake mode occurs upon termination of brake-by-wire control or when at least one of sub-ECUs 100-200 becomes failed. As previously described, first and second stroke sensors S/Sen1-S/Sen2 are provided at the master cylinder M/C. Two stroke signals S1-S2, each indicating a stroke of brake pedal BP, are generated from respective stroke sensors S/Sen1-S/Sen2 to main ECU 300.

[Hydraulic Units]

Referring now to FIG. 19, there is shown the hydraulic circuit diagram of first hydraulic unit HU1. Components incorporated in first hydraulic unit HU1 are electromagnetic valves (directional control valves), first pump P1, and first motor M1. The electromagnetic valves are constructed by shutoff valve S.OFF/V, front-left inflow valve IN/V(FL), rear-right inflow valve IN/V(RR), front-left outflow valve OUT/V(FL), and rear-right outflow valve OUT/V(RR). The valve openings of these valves S.OFF/V, IN/V(FL), IN/V(RR), OUT/V(FL), and OUT/V(RR) are preset such that the ratio of a fluid pressure for front wheels FL, FR to a fluid pressure for rear wheels RL, RR is 2:1.

A discharge line (a pump outlet line) Fl of pump P1 is connected through a fluid line C1(FL) to front-left wheel cylinder W/C(FL). Discharge line Fl is also connected through a fluid line C1(RR) to rear-right wheel cylinder W/C(RR). A suction line (a pump inlet line) H1 of pump P1 is connected through fluid line B1 to master-cylinder reservoir RSV. Fluid line C1(FL) is connected through a fluid line E1(FL) to fluid line B1, whereas fluid line C1(RR) is connected through a fluid line E1(RR) to fluid line B1.

A joining point I1 of fluid line C1(FL) and fluid line E1(FL) is connected through fluid line A1 to master cylinder M/C. Furthermore, a joining point J1 of fluid line C1(FL) and fluid line C1(RR) is connected through a fluid line G1 to fluid line B1.

Shutoff valve S.OFF/V is comprised of a normally-open electromagnetic valve, and fluidly disposed in fluid line A1 for establishing or blocking fluid communication between master cylinder M/C and joining point I1.

Front-left inflow valve IN/V(FL) is fluidly disposed in fluid line C1(FL), and comprised of a normally-open proportional control valve that regulates the discharge pressure produced by pump P1 by way of proportional control action and then supplies the proportional-controlled fluid pressure to front-left wheel cylinder W/C(FL). Similarly, rear-right inflow valve IN/V(RR) is fluidly disposed in fluid line C1(RR), and comprised of a normally-open proportional control valve that regulates the discharge pressure produced by pump P1 by way of proportional control action and then supplies the proportional-controlled fluid pressure to rear-right wheel cylinder W/C(RR). Backflow-prevention check valves C/V(FL)-C/V(RR) are fluidly disposed in respective fluid lines C1(FL)-C1(RR) to prevent working fluid from flowing back to the discharge port of pump P1.

Front-left and rear-right outflow valves OUT/V(FL)-OUT/V(RR) are fluidly disposed in respective fluid lines E1(FL)-E1(RR). Front-left outflow valve OUT/V(FL) is comprised of a normally-closed proportional control valve, whereas rear-right outflow valve OUT/V(RR) is comprised of a normally-open proportional control valve. Relief valve Ref/V is fluidly disposed in fluid line G1.

First M/C pressure sensor MC/Sen1 is provided or screwed into fluid line A1 interconnecting first hydraulic unit HU1 and master cylinder M/C, for detecting master-cylinder pressure Pm1 and for generating a signal indicative of the detected master-cylinder pressure to main ECU 300. Front-left and rear-right wheel-cylinder pressure sensors WC/Sen(FL)-WC/Sen(RR) are incorporated into first hydraulic unit HU1 and provided or screwed into respective fluid lines C1(FL)-C1(RR), for detecting actual front-left and rear-right wheel cylinder pressures Pfl and Prr. A first pump discharge pressure sensor P1/Sen is provided or screwed into discharge line F1 for detecting discharge pressure Pp1 discharged from first pump P1. Signals indicative of the detected values Pfl, Prr, and Pp1 are generated from the respective sensors WC/Sen(FL)-WC/Sen(RR) and P1/Sen to first sub-ECU 100.

[Normal Braking During Brake-by-Wire Control]

(During Pressure Buildup)

During normal braking at a pressure buildup mode, shutoff valve S.OFF/V is kept closed, inflow valves IN/V(FL)-IN/V(RR) are kept open, outflow valves OUT/V(FL)-OUT/V(RR) are kept closed, and motor M1 is rotated. Thus, pump P1 is driven by motor M1, and thus a discharge pressure is supplied from pump P1 through discharge line Fl to fluid lines C1(FL)-C1(RR). Then, the regulated working fluid, proportional-controlled by front-left inflow valve IN/V(FL), is introduced from inflow valve IN/V(FL) via a fluid line D1(FL) into front-left wheel cylinder W/C(FL). Likewise, the regulated working fluid, proportional-controlled by rear-right inflow valve IN/V(RR), is introduced from inflow valve IN/V(RR) via a fluid line D1(RR) into rear-right wheel cylinder W/C(RR). In this manner, a pressure buildup mode can be achieved.

(During Pressure Reduction)

During normal braking at a pressure reduction mode, inflow valves IN/V(FL)-IN/V(RR) are kept closed, while outflow valves OUT/V(FL)-OUT/V(RR) are kept open. Thus, front-left and rear-right wheel cylinder pressures Pfl-Prr are exhausted through outflow valves OUT/V(FL)-OUT/V(RR) via fluid line B1 into reservoir RSV.

(During Pressure Hold)

During normal braking at a pressure hold mode, inflow valves IN/V(FL)-IN/V(RR) and outflow valves OUT/V(FL)-OUT/V(RR) are all kept closed, so as to hold or retain front-left and rear-right wheel cylinder pressures Pfl-Prr unchanged.

[Manual Brake]

When the operating mode of the BBW system equipped brake control apparatus has been switched to a manual brake mode owing to a system failure, shutoff valve S.OFF/V becomes open, and inflow valves IN/V(FL)-IN/V(RR) become closed. As a result of this, master-cylinder pressure Pm is not delivered to rear-right wheel cylinder W/C(RR). On the other hand, front-left outflow valve OUT/V(FL) is comprised of a normally-closed valve and therefore the outflow valve OUT/V(FL) is kept closed during the manual brake mode. Front-left wheel cylinder W/C(FL) becomes conditioned in a master-cylinder pressure application state. Thus, master-cylinder pressure Pm, built up by the driver's brake-pedal depression, can be applied to front-left wheel cylinder W/C(FL). In this manner, the manual brake mode can be achieved or ensured.

Suppose that master-cylinder pressure Pm is applied to rear-right wheel cylinder W/C(RR) as well as front-left wheel cylinder W/C(FL) during the manual brake mode. When building up rear-right wheel-cylinder pressure Prr as well as front-left wheel-cylinder pressure Pfl by leg-power by the driver's foot, there is a problem of unnatural feeling that the driver experiences an excessive leg-power load. This is not realistic. For this reason, for the first hydraulic unit HU1 during the manual brake mode, the brake system of the shown embodiment is configured to apply master-cylinder pressure Pm to only the front-left road wheel FL, which generates a relatively great braking force in comparison with rear-right road wheel RR. Therefore, rear-right outflow valve OUT/V(RR) is constructed as a normally-open valve, for rapidly exhausting the residual pressure in rear-right wheel cylinder W/C(RR) into reservoir RSV and for avoiding undesirable rear-right wheel lock-up.

Referring now to FIG. 20, there is shown the hydraulic circuit diagram of second hydraulic unit HU2. Components incorporated in second hydraulic unit HU2 are electromagnetic valves, second pump P2, and second motor M2. The electromagnetic valves are constructed by shutoff valve S.OFF/V, front-right inflow valve IN/V(FR), rear-left inflow valve IN/V(RL), front-right outflow valve OUT/V(FR), and rear-left outflow valve OUT/V(RL). The valve openings of these valves S.OFF/V, IN/V(FR), IN/V(RL), OUT/V(FR), and OUT/V(RL) are preset such that the ratio of a fluid pressure for front wheels FL, FR to a fluid pressure for rear wheels RL, RR is 2:1. The hydraulic circuit configurations and control operations are the same in both first and second hydraulic units HU1-HU2. In explaining second hydraulic unit HU2, for the purpose of simplification of the disclosure, detailed description of the similar components will be omitted because the above description thereon seems to be self-explanatory. In a similar manner to first hydraulic unit HU1, regarding second hydraulic unit HU2, front-right outflow valve OUT/V(FR) is comprised of a normally-closed proportional control valve, whereas rear-left outflow valve OUT/V(RL) is comprised of a normally-open proportional control valve. For the second hydraulic unit HU2 during the manual brake mode, the brake system of the shown embodiment is configured to apply master-cylinder pressure Pm to only the front-right road wheel FR, which generates a relatively great braking force in comparison with rear-left road wheel RL. As previously noted, rear-left outflow valve OUT/V(RL) is constructed as a normally-open valve, for rapidly exhausting the residual pressure in rear-left wheel cylinder W/C(RL) into reservoir RSV and for avoiding undesirable rear-left wheel lock-up.

[Abnormality Detection Control in Fourth Embodiment]

Basically, the abnormality detection control of the fourth embodiment is similar to that of the first embodiment (or the third embodiment). The rear-wheel BBW system equipped brake control apparatus of the third embodiment is applied to a so-called fore-and-aft parallel split layout of brake circuits, in which the first (front) wheel-brake system includes a first pair of parallelly-arranged wheel-brake cylinders W/C(FL) and W/C(FR) and the second (rear) wheel-brake system includes a second pair of parallelly-arranged wheel-brake cylinders W/C(RL) and W/C(RR), and the two parallel-split pairs are controlled independently of each other. On the other hand, the four-wheel BBW system equipped brake control apparatus of the fourth embodiment is applied to a so-called diagonal split layout of brake circuits, in which the first wheel-brake system includes a first pair of diagonally-opposed wheel-brake cylinders W/C(FL) and W/C(RR) and the second wheel-brake system includes a second pair of diagonally-opposed wheel-brake cylinders W/C(FR) and W/C(RL), and the two diagonal-split pairs are controlled independently of each other. In the case of abnormality detection control for the brake control apparatus of the first or third embodiment, the deviation-to-deviation difference calculation means is configured to calculate a difference ΔPFL−ΔPFR (or ΔPRL−ΔPRR) between the fluid-pressure deviation ΔPFL (or ΔPRL) of one of the parallelly-arranged wheel-brake cylinders W/C (FL)-W/C(FR) (or W/C(RL)-W/C(RR)) and the fluid-pressure deviation ΔPFR (or ΔPRR) of the other wheel-brake cylinder. In contrast, in the case of abnormality detection control for the brake control apparatus of the fourth embodiment, the deviation-to-deviation difference calculation means is configured to calculate a difference ΔPFL−ΔPRR (or ΔPFR−ΔPRL) between the fluid-pressure deviation ΔPFL (or ΔPFR) of one of the diagonally-opposed wheel-brake cylinders W/C(FL)-W/C(RR) (or W/C(FR)-W/C(RL)) and the fluid-pressure deviation ΔPRR (or ΔPRL) of the other wheel-brake cylinder. It is possible to more certainly decide the presence or absence of the hydraulic-brake system abnormality by comparison of the calculated deviation-to-deviation difference ΔPFL−ΔPRR (or ΔPFR−ΔPRL) between the diagonally-opposed road wheels with the predetermined threshold value k. Thus, the brake control apparatus of the fourth embodiment can achieve precise abnormality detection in a similar manner to the first embodiment. Additionally, by way of comparison of each of the calculated fluid-pressure deviations ΔPFL, ΔPRR, ΔPFR, ΔPRL with the predetermined threshold value k, it is possible to accurately specify or determine which of the hydraulic-brake systems is leaking (failed or abnormal) or which of the wheel-brake cylinders is leaking (failed or abnormal).

Additionally, in the brake control apparatus of the fourth embodiment, the orifice-constriction flow passage area “A” of the orifice portion of each of inflow valves IN/V(FL, FR, RL, RR) is set or adjusted to satisfy the previously-described mathematical expressions, that is,

Pv=(Q²ρ)/(2·A²·C²) and Pv(max)≧(Pv1,Pv2).

Thus, by executing the same abnormality detection control as the first embodiment for the first wheel-brake system including a first pair of diagonally-opposed wheel-brake cylinders W/C(FL) and W/C(RR) as well as the second wheel-brake system including a second pair of diagonally-opposed wheel-brake cylinders W/C(FR) and W/C(RL), the brake control apparatus of the fourth embodiment can provide the following effects.

[Effects of Fourth Embodiment]

(1-11) In the fourth embodiment shown in FIGS. 18-20, hydraulic actuators are constructed by first and second hydraulic units HU1-HU2 having respective fluid-pressure sources, namely, the first fluid-pressure source (first pump P1) and the second fluid-pressure source (second pump P2). Four wheel-brake cylinders W/C(FL-RR) are mounted on respective road wheels FL, FR, RL, and RR. First hydraulic unit HU1 is connected to front-left and rear-right wheel-brake cylinders W/C(FL, RR) for controlling or regulating front-left and rear-right wheel cylinder pressures Pfl and Prr, while second hydraulic unit HU2 is connected to front-right and rear-left wheel-brake cylinders W/C(FR, RL) for controlling or regulating front-right and rear-left wheel cylinder pressures Pfr and Prl.

Thus, it is possible to provide almost the same effects (1), (1-1), (1-4), (1-5), (1-6), and (2-7) as the first embodiment, in a dual-hydraulic-unit, four-wheel BBW control system equipped four-wheeled vehicle employing a diagonal split layout (X-split layout) of brake circuits.

As previously discussed, first hydraulic unit HU1 having first fluid-pressure source (first pump P1) and second hydraulic unit HU2 having second fluid-pressure source (second pump P2) are provided as hydraulic actuators (hydraulic modulators). First hydraulic unit HU1 is configured to control or regulate fluid pressures Pfl and Prr of front-left and rear-right wheel-brake cylinders W/C(FL, RR) via the first fluid-pressure source (first pump P1), while second hydraulic unit HU1 is configured to control or regulate fluid pressures Pfr and Prl of front-right and rear-left wheel-brake cylinders W/C(FR, RL) via the second fluid-pressure source (second pump P1). Thus, it is possible to easily provide or realize a brake-by-wire system equipped vehicle by applying the brake control apparatus of the fourth embodiment to an automotive vehicle employing a general diagonal split layout (X-split layout) of brake circuits.

As previously discussed, the first fluid-pressure source is comprised of first pump P1, whereas the second fluid-pressure source is comprised of second pump P2. The fluid pressures in wheel-brake cylinders W/C(FL) to W/C(RR) can be built up directly by means of these pumps P1-P2. It is possible to build up wheel cylinder pressures Pfl to Prr without using any pressure accumulators, and thus there is no risk of undesirable blending (leakage) of gas in the accumulator into working fluid in the fluid lines in the presence of a brake system failure. Such an accumulatorless hydraulic brake system contributes to smaller space requirements of overall system.

Moreover, in the fourth embodiment, first and second hydraulic units HU1-HU2 are configured as separate units. Therefore, even if an oil leakage occurs in either one of first and second hydraulic units HU1-HU2, it is possible to produce or secure a braking force by means of the other unfailed hydraulic unit that an oil leakage does not occur.

First and second hydraulic units HU1-HU2 are configured as separate units, but it is preferable that these hydraulic units HU1-HU2 are integrally connected to each other. In the case of integral construction of hydraulic units HU1-HU2, electric circuit configurations can be gathered to one place, thus realizing shortened harness lengths and simplified brake system layout.

Electric power is supplied from first electric power source BATT1 to first hydraulic unit HU1, whereas electric power is supplied from second electric power source BATT2 to second hydraulic unit HU2. Thus, even if either first electric power source BATT1 or second electric power source BATT2 is failed, either one of hydraulic units HU1-HU2 can be driven or operated by means of the unfailed electric power source, thus securing a braking force.

(Modified Systems)

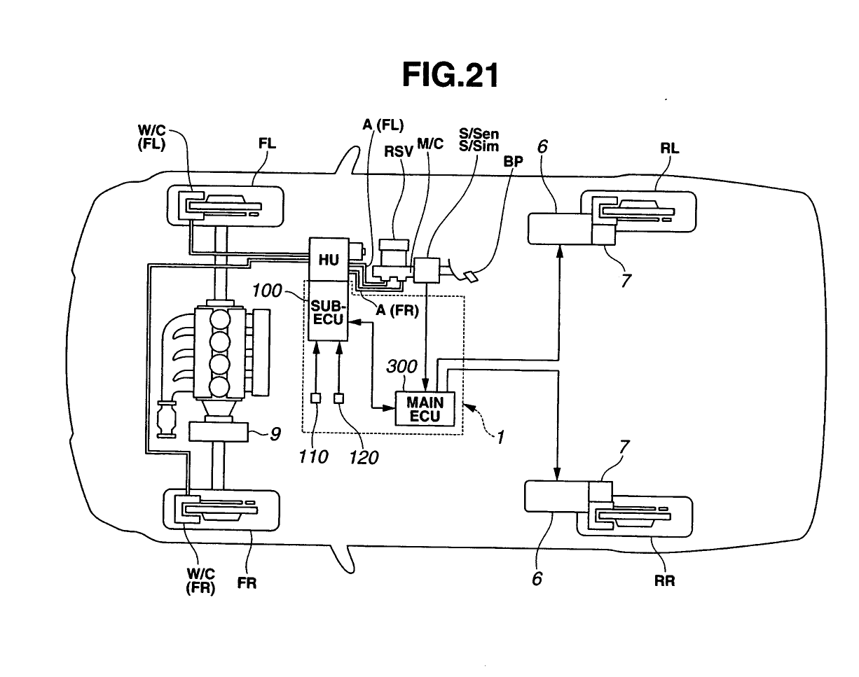

Referring now to FIG. 21, there is shown the brake control system modified from the first embodiment.

(2) In the first embodiment, step S101 (corresponding to a fluid-pressure deviation calculation means) and step S107 (corresponding to a leak detection means), constructing part of the main flow concerning the abnormality detection control processing (the leak detection control routine), are executed within the processor of main ECU 300 (or sub-ECU 100). In order to efficiently perform fluid-pressure deviation ΔP calculation and leak detection, the modified system shown in FIG. 21 further employs an additional fluid-pressure deviation calculation device (an additional fluid-pressure deviation calculation circuit) 110 and an additional leak detector (an additional leak detection circuit) 120, both separated from the main ECU and the sub-ECU. The modified system of FIG. 21 can provide the same effects (1), (1-1), (1-4), (1-5), (1-6), (1-7), and (2-7) as the first embodiment.

(3) Although the control apparatuses of the first to fourth embodiments are exemplified in a brake-by-wire control system equipped automotive vehicle, it will be understood that the invention is not limited to the particular embodiments shown and described herein. The fundamental concept of the invention can be applied to a plurality of fluid-pressure-control controlled systems (e.g., wheel-brake cylinders in the previously-described embodiments), each of which is subjected to fluid-pressure control. For example, the inventive concept may be applied to a pump-up system that a control valve device having a flow-constriction throttling portion (or an orifice ensuring an orifice constriction effect) is disposed a pump and each individual fluid-pressure-control controlled system.

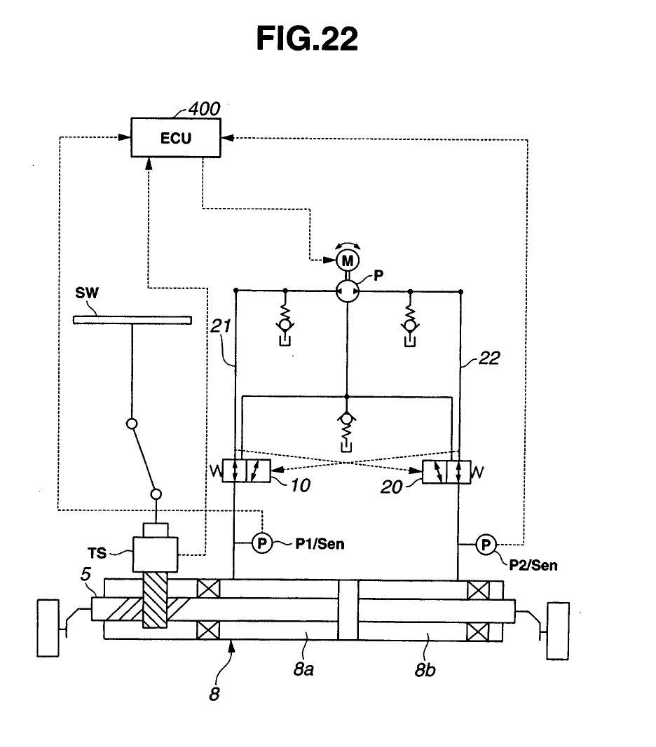

Referring now to FIG. 22, there is shown another modification that the inventive concept is applied to a pump-up system such as a hydraulic-power-cylinder equipped power steering device. As shown in FIG. 22, the power steering device is comprised of a torque sensor TS provided for detecting a steering torque applied to a steering wheel SW by the driver, a reversible pump P, a hydraulic power cylinder 8 configured to assist a steering force of a rack shaft 5 linked to steered road wheels and defining therein a left-hand cylinder chamber 8a and a right-hand cylinder chamber 8b, a first selector valve (a first directional control valve 10) disposed in a first pressure line 21 interconnecting pump P and left-hand cylinder chamber 8a, and a second selector valve (a second directional control valve 20) disposed in a second pressure line 22 interconnecting pump P and right-hand cylinder chamber 8b. Also provided are a first fluid-pressure sensor P1/Sen for detecting a fluid pressure P₁₀ in the fluid line 21 connected to left-hand cylinder chamber 8a and a second fluid-pressure sensor P2/Sen for detecting a fluid pressure P₂₀ in the fluid line 22 connected to right-hand cylinder chamber 8b. An electronic control unit (ECU) 400 is configured to control a driving state of a pump motor M responsively to sensor signals from torque sensor TS, and first and second fluid-pressure sensors P1/Sen-P2/Sen, thus enabling proper steering assist force application to rack shaft 5 by building up the fluid pressure in a selected one of left and right cylinder chambers 8a-8b of hydraulic power cylinder 8. As clearly shown in FIG. 22, each of the first and second directional control valves 10-20 is comprised of a 3-port, 2-position, spring-offset, pilot-operation directional control valve. The first pilot-operation directional control valve 10 receives the fluid pressure in second pressure line 22 via a pilot operation line as an external pilot pressure. In a similar manner, the second pilot-operation directional control valve 20 receives the fluid pressure in first pressure line 21 via a pilot operation line as an external pilot pressure. That is, the valve position of each of pilot-operation directional control valves 10 and 20 can be changed mechanically depending on the differential pressure (P₁₀−P₂₀) between first and second pressure lines 21-22. When the first pilot-operation directional control valve 10 is held at its spring-loaded position, fluid communication between the upstream and downstream passage sections of first pressure line 21 is established. Conversely when the first pilot-operation directional control valve 10 is held at its drain position owing to a differential pressure (P₁₀−P₂₀<0), the downstream passage section of first pressure line 21 is communicated with a reservoir through a reservoir communication passage. When the second pilot-operation directional control valve 20 is held at its spring-loaded position, fluid communication between the upstream and downstream passage sections of second pressure line 22 is established. Conversely when the second pilot-operation directional control valve 20 is held at its drain position owing to a differential pressure (P₂₀−P₁₀<0), the downstream passage section of second pressure line 22 is communicated with the reservoir through the reservoir communication passage. In the case of the modification shown in FIG. 22, left and right hydraulic power cylinder chambers 8a-8b are regarded as a plurality of fluid-pressure-control controlled systems. Each of first and second directional control valves 10-20 (first and second selector valves) is regarded as a control valve device having a flow-constriction throttling portion (or an orifice ensuring an orifice constriction effect) disposed between pump P and each individual fluid-pressure-control controlled system 8a-8b. ECU 400 is also configured to stop or inhibit working-fluid supply from pump P to the abnormal cylinder chamber having an abnormality in a fluid-pressure deviation between the actual cylinder chamber pressure detected by the fluid-pressure sensor (P1/Sen or P2/Sen) and a target cylinder chamber pressure. In the case of the pump-up system (the hydraulic-power-cylinder equipped power steering device) of FIG. 22, as soon as a hydraulic power cylinder system abnormality has been decided, motor M is de-energized for inhibiting steering assist control and for stopping or inhibiting working-fluid supply from the fluid-pressure source (pump P) to the abnormal cylinder chamber having a fluid-pressure deviation abnormality. Therefore, it is possible to certainly avoid or prevent a further leak from the leaking portion of the failed hydraulic power cylinder system (or the abnormal cylinder chamber) having a possibility of a working-fluid leak.

The entire contents of Japanese Patent Application No. 2007-070971 (filed Mar. 19, 2007) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A brake control apparatus of an automotive vehicle comprising:
wheel-brake cylinders mounted on each of at least two road wheels;
pressure sensors provided for detecting actual wheel cylinder pressures in the respective wheel-brake cylinders;
a vehicle sensor provided for detecting a driver's manipulated variable;
at least one hydraulic actuator configured to regulate the actual wheel cylinder pressures;
at least one pump incorporated in the hydraulic actuator;
a separate pressure buildup valve disposed in each separate wheel-brake line through which working fluid discharged from the pump is introduced into each of the wheel-brake cylinders, the pressure buildup valve having an orifice having a predetermined orifice-constriction flow passage area;
a controller configured to be connected to at least the pressure sensors, the vehicle sensor, and the hydraulic actuator, for calculating, based on the driver's manipulated variable, target wheel cylinder pressures, and for controlling the hydraulic actuator responsively to the target wheel cylinder pressures;
the controller configured to calculate a fluid-pressure deviation between the target wheel cylinder pressure and the actual wheel cylinder pressure for each of the wheel-brake cylinders; and
the controller further configured to stop working-fluid supply from the pump to the abnormal wheel-brake cylinder having an abnormality in the fluid-pressure deviation exceeding a predetermined threshold value.

2. The brake control apparatus as claimed in claim 1, wherein:
the controller comprises a fluid-pressure deviation calculation circuit that calculates the fluid-pressure deviations, and a deviation-to-deviation difference calculation circuit that calculates a difference between the fluid-pressure deviation of a first one of the wheel-brake cylinders and the fluid-pressure deviation of a second one of the wheel-brake cylinders for comparing the calculated difference with the predetermined threshold value to specify the abnormal wheel-brake cylinder.

3. The brake control apparatus as claimed in claim 1, wherein:
the controller is configured to fully close the pressure buildup valve associated with the abnormal wheel-brake cylinder having the abnormality in the fluid-pressure deviation, for stopping working-fluid supply from the pump to the abnormal wheel-brake cylinder having the abnormality in the fluid-pressure deviation.

4. The brake control apparatus as claimed in claim 1, wherein:
the controller is configured to increase an outflow quantity of working fluid discharged from the pump, when the fluid-pressure deviation exceeds the predetermined threshold value.

5. The brake control apparatus as claimed in claim 3, wherein:
the controller is configured to increase an outflow quantity of working fluid discharged from the pump, when the fluid-pressure deviation exceeds the predetermined threshold value.

6. The brake control apparatus as claimed in claim 2, wherein:
the controller is configured to fully close the pressure buildup valve associated with the abnormal wheel-brake cylinder having the abnormality in the fluid-pressure deviation, for stopping working-fluid supply from the pump to the abnormal wheel-brake cylinder having the abnormality in the fluid-pressure deviation.

7. The brake control apparatus as claimed in claim 3, wherein:
the predetermined orifice-constriction flow passage area of the orifice of each of the pressure buildup valves is set to satisfy mathematical expressions Pv=(Q²·ρ)/(2·A²·C²) and Pv≧MAX(Pv1, Pv2), where Pv denotes an orifice fore-and-aft differential pressure between a fluid pressure upstream of the orifice and a fluid pressure downstream of the orifice, Q denotes a hydraulic system maximum flow quantity of working fluid supplied from the pump into the hydraulic actuator and regulated by the hydraulic actuator, ρ denotes a density of working fluid, A denotes the predetermined orifice-constriction flow passage area, C denotes a flow coefficient of the orifice, Pv1 denotes an orifice fore-and-aft differential pressure of the orifice of the pressure buildup valve associated with the abnormal wheel-brake cylinder and needed to detect the abnormality in the fluid-pressure deviation, and Pv2 denotes an orifice fore-and-aft differential pressure of the orifice of the pressure buildup valve associated with the abnormal wheel-brake cylinder and regarded as to be equal to a necessary wheel cylinder pressure required for the normally operating wheel-brake cylinder in the presence of the abnormality in the fluid-pressure deviation, and the expression Pv≧MAX(Pv1, Pv2) defines that a higher one MAX(Pv1, Pv2) of the two orifice fore-and-aft differential pressures Pv1 and Pv2 is selected as the orifice fore-and-aft differential pressure Pv.

8. The brake control apparatus as claimed in claim 1, wherein:
the wheel-brake cylinders are mounted on each of front-left, front-right, rear-left, and rear-right road wheels of the vehicle; and
the pump comprises a common pump connected to each of the front-left, front-right, rear-left, and rear-right wheel-brake cylinders for brake-by-wire control.

9. The brake control apparatus as claimed in claim 1, wherein:
a first wheel-brake group comprises a hydraulic wheel brake system having the wheel-brake cylinders connected to the pump for brake-by-wire control; and
a second wheel-brake group comprises either one of a master-cylinder pressure operated wheel brake system and an electric-operated brake caliper system.

10. The brake control apparatus as claimed in claim 8, wherein:
the controller comprises a fluid-pressure deviation calculation circuit that calculates the fluid-pressure deviations, and a deviation-to-deviation difference calculation circuit that calculates a difference between the fluid-pressure deviation of a first one of the wheel-brake cylinders and the fluid-pressure deviation of a second one of the wheel-brake cylinders for comparing the calculated difference with the predetermined threshold value to specify the abnormal wheel-brake cylinder.

11. The brake control apparatus as claimed in claim 10, wherein:
the controller is configured to fully close the pressure buildup valve associated with the abnormal wheel-brake cylinder having the abnormality in the fluid-pressure deviation, for stopping working-fluid supply from the pump to the abnormal wheel-brake cylinder having the abnormality in the fluid-pressure deviation.

12. The brake control apparatus as claimed in claim 1, wherein:
abnormality detection processing for the abnormality in the fluid-pressure deviation is initiated responsively to a transition from an ignition-switch ON state to an ignition-switch OFF state.

13. A brake control apparatus of an automotive vehicle comprising:
wheel-brake cylinders mounted on each of at least two road wheels;
a fluid-pressure sensor means for detecting actual wheel cylinder pressures in the respective wheel-brake cylinders;
a vehicle sensor means for detecting a driver's manipulated variable;
at least one hydraulic actuator configured to regulate the actual wheel cylinder pressures;
a fluid-pressure supply means incorporated in the hydraulic actuator;
a flow-constriction valve means disposed in each separate wheel-brake line through which working fluid discharged from the fluid-pressure supply means is introduced into each of the wheel-brake cylinders, the flow-constriction valve means having an orifice having a predetermined orifice-constriction flow passage area;
a control means configured to be connected to at least the fluid-pressure sensor means, the vehicle sensor means, and the hydraulic actuator, for calculating, based on the driver's manipulated variable, target wheel cylinder pressures, and for controlling the hydraulic actuator responsively to the target wheel cylinder pressures;
a fluid-pressure deviation arithmetic-calculation-and-logic means for calculating a fluid-pressure deviation between the target wheel cylinder pressure and the actual wheel cylinder pressure for each of the wheel-brake cylinders and for deciding that there is an abnormality in the fluid-pressure deviation when the fluid-pressure deviation exceeds a predetermined threshold value; and
the control means further configured to stop working-fluid supply from the fluid-pressure supply means to the abnormal wheel-brake cylinder having the abnormality in the fluid-pressure deviation exceeding the predetermined threshold value, when the fluid-pressure deviation arithmetic-calculation-and-logic means decides that there is the abnormality in the fluid-pressure deviation.

14. The brake control apparatus as claimed in claim 13, wherein:
the fluid-pressure deviation arithmetic-calculation-and-logic means further comprises a deviation-to-deviation difference calculation means that calculates a difference between the fluid-pressure deviation of a first one of the wheel-brake cylinders and the fluid-pressure deviation of a second one of the wheel-brake cylinders for comparing the calculated difference with the predetermined threshold value to specify the abnormal wheel-brake cylinder.

15. The brake control apparatus as claimed in claim 13, wherein:
the control means is configured to fully close the flow-constriction valve means associated with the abnormal wheel-brake cylinder having the abnormality in the fluid-pressure deviation, for stopping working-fluid supply from the fluid-pressure supply means to the abnormal wheel-brake cylinder having the abnormality in the fluid-pressure deviation.

16. The brake control apparatus as claimed in claim 15, wherein:
the control means is configured to increase an outflow quantity of working fluid discharged from the fluid-pressure supply means, when the fluid-pressure deviation exceeds the predetermined threshold value.

17. The brake control apparatus as claimed in claim 15, wherein:
the predetermined orifice-constriction flow passage area of the orifice is set to satisfy mathematical expressions Pv=(Q²·ρ)/(2·A²·C²) and Pv≧MAX(Pv1, Pv2), where Pv denotes an orifice fore-and-aft differential pressure between a fluid pressure upstream of the orifice and a fluid pressure downstream of the orifice, Q denotes a hydraulic system maximum flow quantity of working fluid supplied from the fluid-pressure supply means into the hydraulic actuator and regulated by the hydraulic actuator, ρ denotes a density of working fluid, A denotes the predetermined orifice-constriction flow passage area, C denotes a flow coefficient of the orifice, Pv1 denotes an orifice fore-and-aft differential pressure of the orifice associated with the abnormal wheel-brake cylinder and needed to detect the abnormality in the fluid-pressure deviation, and Pv2 denotes an orifice fore-and-aft differential pressure of the orifice associated with the abnormal wheel-brake cylinder and regarded as to be equal to a necessary wheel cylinder pressure required for the normally operating wheel-brake cylinder in the presence of the abnormality in the fluid-pressure deviation, and the expression Pv≧MAX(Pv1, Pv2) defines that a higher one MAX(Pv1, Pv2) of the two orifice fore-and-aft differential pressures Pv1 and Pv2 is selected as the orifice fore-and-aft differential pressure Pv.

18. The brake control apparatus as claimed in claim 13, wherein:
the wheel-brake cylinders are mounted on each of front-left, front-right, rear-left, and rear-right road wheels of the vehicle; and
the fluid-pressure supply means comprises a common pump connected to each of the front-left, front-right, rear-left, and rear-right wheel-brake cylinders for brake-by-wire control.

19. The brake control apparatus as claimed in claim 13, wherein:
the fluid-pressure supply means comprises a pump;
a first wheel-brake group comprises a hydraulic wheel brake system having the wheel-brake cylinders connected to the pump for brake-by-wire control; and
a second wheel-brake group comprises either one of a master-cylinder pressure operated wheel brake system and an electric-operated brake caliper system.

20. The brake control apparatus as claimed in claim 19, wherein:
the fluid-pressure deviation arithmetic-calculation-and-logic means further comprises a deviation-to-deviation difference calculation means that calculates a difference between the fluid-pressure deviation of a first one of the wheel-brake cylinders and the fluid-pressure deviation of a second one of the wheel-brake cylinders for comparing the calculated difference with the predetermined threshold value to specify the abnormal wheel-brake cylinder.

21. The brake control apparatus as claimed in claim 20, wherein:
the control means is configured to fully close the flow-constriction valve means associated with the abnormal wheel-brake cylinder having the abnormality in the fluid-pressure deviation, for stopping working-fluid supply from the fluid-pressure supply means to the abnormal wheel-brake cylinder having the abnormality in the fluid-pressure deviation.

22. The brake control apparatus as claimed in claim 13, wherein:
abnormality detection processing for the abnormality in the fluid-pressure deviation is initiated responsively to a transition from an ignition-switch ON state to an ignition-switch OFF state.

23. A pump-up system comprising:
a pump;
a motor that drives the pump;
a plurality of fluid-pressure-control controlled systems, each of which is connected to the pump;
pressure sensors provided for detecting actual fluid pressures in the respective fluid-pressure-control controlled systems;
a vehicle sensor provided for detecting a driver's manipulated variable;
a separate control valve disposed in each separate fluid line through which working fluid discharged from the pump is introduced into each of the fluid-pressure-control controlled systems, the control valve having an orifice having a predetermined orifice-constriction flow passage area;
a controller configured to be connected to at least the pressure sensors, the vehicle sensor, and the motor, for calculating, based on the driver's manipulated variable, target fluid pressures in the fluid-pressure-control controlled systems, and for controlling the motor responsively to the target fluid pressures;
the controller configured to calculate a fluid-pressure deviation between the target fluid pressure and the actual fluid pressure for each of the fluid-pressure-control controlled systems; and
the controller further configured to stop working-fluid supply from the pump to the abnormal fluid-pressure-control controlled system having an abnormality in the fluid-pressure deviation exceeding a predetermined threshold value.

24. The pump-up system as claimed in claim 23, wherein:
the controller is configured to stop the motor, for stopping working-fluid supply from the pump to the abnormal fluid-pressure-control controlled system having the abnormality in the fluid-pressure deviation.
